(19) United States
(12) Patent Application Publication
(10) Pub. No.: US 2018/0141068 A1
(43) Pub. Date: May 24, 2018

(54) Touch Spray Head

(71) Applicant: Globe Union Industrial Corp., Taichung City (TW)

(72) Inventors: Huiling Chiu, Taichung City (TW); Chiahua Yuan, Taichung City (TW); Yiping Lin, Taichung City (TW); Yuanhao Chang, Taichung City (TW)

(21) Appl. No.: 15/857,956

(22) Filed: Dec. 29, 2017

Related U.S. Application Data
(63) Continuation-in-part of application No. 15/189,087, filed on Jun. 22, 2016.

(30) Foreign Application Priority Data
Aug. 25, 2015 (TW) 104127758

(51) Int. Cl. B05B 12/00; E03C 1/04; E03C 1/10

(52) U.S. Cl. CPC B05B 12/002; F16K 31/52475; E03C 1/10; E03C 1/0405

(57) ABSTRACT

A touch spray head is removably connected on an outlet of a faucet body and contains: a casing, a fixing cylinder, a water valve, and a manual operation. The casing includes a surrounding fence, an accommodation space, and a through hole. The fixing cylinder is housed in the accommodation space and includes an inlet segment communicating with the outlet, an outlet segment, at least one first orifice defined between the inlet segment and the outlet segment, and a receiving zone. The water valve is accommodated in the fixing cylinder and includes an operation bar touched to movably turn on the water valve. The manual operation device is housed in the receiving zone and the through hole, and the manual operation device includes a driving portion formed in the through hole so as to be driven by a user to actuate the operation bar to move.

This application is a Continuation-in-Part of application Ser. No 15/189,087, filed Jun. 22, 2016.

### BACKGROUND OF THE INVENTION

### Field of the Invention

The present invention relates to a touch spray head which turns on/off water in a manual operation manner.

### Description of the Prior Art

A conventional control valve for a spray head of a faucet is manufactured at high cost and is complicated. Accordingly, improved touch control valves were disclosed in TW Patent Nos. M432670, 1228578, 1369459, M452280 and M382408, respectively. The improved touch control valves are an automatic valve or a manual valve, wherein when the touch control valves are the manual valve, water supply is stopped by touching an actuation element, after starting the water supply. When the touch control valves are the automatic valve, the water supply is stopped automatically by way of water pressure change after a period of using time.

In addition, one touch control valves are sold by many companies, such as 3M, wherein each one touch control valve is fixed on an outlet of the faucet and the water supply is started or stopped by manually touching an actuation element in the control valve, thus causing contamination to the actuation element.

A conventional faucet contains a handle and a central shaft driven by the handle so as to control water supply or to adjust temperature of the water supply. But an operation travel is too long to operate the faucet smoothly and to obtain aesthetics appearance of the control valve.

Another conventional faucet contains an infrared sensor disposed on a body so as to sense user's hand by which water is supplied, yet the conventional faucet cannot be controlled as the infrared sensor or a circuit board is broken.

The present invention has arisen to mitigate and/or obviate the afore-described disadvantages.

### SUMMARY OF THE INVENTION

The primary aspect of the present invention is to provide a touch spray head in which the water valve is driven by the tubular part so as to avoid touching and contaminating the water valve.

Further aspect of the present invention is to provide a touch spray head which sprays the water in different water spraying modes by way of the switch valve assembly.

Another aspect of the present invention is to provide a touch spray head in which the tubular part is rotatably connected with the fixing cylinder so as to simplify the touch spray head and to reduce fabrication cost.

To obtain the above aspects, a touch spray head provided by the present invention is removably connected on an outlet of a faucet body and contains: a casing, a fixing cylinder, a water valve, a manual operation device.

The casing includes a surrounding fence, an accommodation space defined inside the surrounding fence, and a through hole formed on the surrounding fence and communicating with the accommodation space.

The fixing cylinder is housed in the accommodation space of the casing and includes an inlet segment communicating with the outlet of the faucet body, an outlet segment, at least one first orifice defined between the inlet segment and the outlet segment, and a receiving zone.

The water valve is accommodated in the fixing cylinder and includes an operation bar touched to movably turn on the water valve so that the water flows into the at least one first orifice of the fixing cylinder from the outlet of the faucet body;

The manual operation device is housed in the receiving zone of the fixing cylinder and the through hole of the casing, and the manual operation device includes a driving portion formed in the through hole so as to be driven by a user to actuate the operation bar of the water valve to move.

### BRIEF DESCRIPTION OF THE DRAWINGS

FIG. 1 is a perspective view showing the application of a touch spray head according to a first embodiment of the present invention.

FIG. 2 is a perspective view showing the application of a part of the touch spray head according to the first embodiment of the present invention.

FIG. 3 is a cross sectional view taken along the line 1-1 of FIG. 2.

FIG. 4 is a cross sectional view taken along the line 2-2 of a part of FIG. 2.

FIG. 5 is a perspective view showing the exploded components of the touch spray head according to the first embodiment of the present invention.

FIG. 6 is a cross-sectional perspective view showing the assembly of a fixing cylinder of the touch spray head according to the first embodiment of the present invention.

FIG. 7 is another cross-sectional perspective view showing the assembly of the fixing cylinder of the touch spray head according to the first embodiment of the present invention.

FIG. 8 is a perspective view showing the assembly of a pressing button of the touch spray head according to the first embodiment of the present invention.

FIG. 9 is another perspective view showing the assembly of the pressing button of the touch spray head according to the first embodiment of the present invention.

FIG. 10 is a cross sectional view showing the operation of the touch spray head according to the first embodiment of the present invention.

FIG. 11 is a perspective view showing the application of a touch spray head according to a second embodiment of the present invention.

FIG. 12 is a cross sectional view taken along the line 1-1 of a part of FIG. 11.

FIG. 13 is a cross sectional view taken along the line 2-2 of a part of FIG. 11.

FIG. 14 is a perspective view showing the exploded components of the touch spray head according to the second embodiment of the present invention.

FIG. 15 is a cross-sectional perspective view showing the assembly of a casing of the touch spray head according to the second embodiment of the present invention.

FIG. 16 is a cross-sectional perspective view showing the assembly of a fixing cylinder of the touch spray head according to the second embodiment of the present invention.

FIG. 17 is another cross-sectional perspective view showing the assembly of the fixing cylinder of the touch spray head according to the second embodiment of the present invention.

FIG. 18 is a perspective view showing the assembly of a rotation device of the touch spray head according to the second embodiment of the present invention.

FIG. 19 is a perspective view showing the exploded components of the rotation device of the touch spray head according to the second embodiment of the present invention.

FIG. 20 is another perspective view showing the exploded components of the rotation device of the touch spray head according to the second embodiment of the present invention.

FIG. 21 is a cross sectional view showing the operation of the rotation device of the touch spray head according to the second embodiment of the present invention.

FIG. 22 is a perspective view showing the application of a part of the touch spray head according to a third embodiment of the present invention.

FIG. 23 is a cross sectional view taken along the line 1-1 of a part of FIG. 22.

FIG. 24 is a partial cross-sectional view taken along the line 2-2 of a part of FIG. 22.

FIG. 25 is a perspective view showing the exploded components of the touch spray head according to the third embodiment of the present invention.

FIG. 26 is a cross-sectional perspective view showing the assembly of a fixing cylinder of the touch spray head according to the third embodiment of the present invention.

FIG. 27 is a cross-sectional perspective view showing the assembly of the fixing cylinder of the touch spray head according to the third embodiment of the present invention.

FIG. 28 is a perspective view showing the assembly of a pushing button of the touch spray head according to the third embodiment of the present invention.

FIG. 29 is a cross-sectional perspective view showing the assembly of the pushing button and a casing of the touch spray head according to the third embodiment of the present invention.

FIG. 30 is another cross-sectional perspective view showing the assembly of the pushing button and a casing of the touch spray head according to the third embodiment of the present invention.

FIG. 31 is a cross sectional view showing the operation of the touch spray head according to the third embodiment of the present invention.

FIG. 32 is a perspective view showing the application of a part of the touch spray head according to a fourth embodiment of the present invention.

FIG. 33 is a cross sectional view taken along the line 1-1 of a part of FIG. 32.

FIG. 34 is a partial cross-sectional view taken along the line 2-2 of a part of FIG. 32.

FIG. 35 is a perspective view showing the exploded components of the touch spray head according to the fourth embodiment of the present invention.

FIG. 36 is a cross-sectional perspective view showing the assembly of a fixing cylinder of the touch spray head according to the fourth embodiment of the present invention.

FIG. 37 is a cross-sectional perspective view showing the assembly of the fixing cylinder of the touch spray head according to the fourth embodiment of the present invention.

FIG. 38 is a perspective view showing the exploded components of a rotation device of the touch spray head according to the fourth embodiment of the present invention.

FIG. 39 is another perspective view showing the exploded components of the rotation device of the touch spray head according to the fourth embodiment of the present invention.

FIG. 40 is a cross sectional view showing the operation of the rotation device of the touch spray head according to the fourth embodiment of the present invention.

FIG. 41 is another cross sectional view showing the operation of the rotation device of the touch spray head according to the fourth embodiment of the present invention.

FIG. 42 is a cross-sectional perspective view showing the assembly of a tubular part of the touch spray head according to the fourth embodiment of the present invention.

FIG. 43 is a cross sectional view showing the operation of a part of the touch spray head according to the fourth embodiment of the present invention.

FIG. 44 is another cross sectional view showing the operation of a part of the touch spray head according to the fourth embodiment of the present invention.

FIG. 45 is also another cross sectional view showing the operation of a part of the touch spray head according to the fourth embodiment of the present invention.

FIG. 46 is a cross sectional view showing the operation of the touch spray head according to the fourth embodiment of the present invention.

FIG. 47 is a perspective view showing the application of a part of the touch spray head according to a fifth embodiment of the present invention.

FIG. 48 is a cross sectional view taken along the line 1-1 of a part of FIG. 47.

FIG. 49 is a cross sectional view taken along the line 2-2 of a part of FIG. 47.

FIG. 50 is a perspective view showing the exploded components of a touch spray head according to a fifth embodiment of the present invention.

FIG. 51 is a cross-sectional perspective view showing the assembly of a fixing cylinder of the touch spray head according to the fifth embodiment of the present invention.

FIG. 52 is another cross-sectional perspective view showing the assembly of the fixing cylinder of the touch spray head according to the fifth embodiment of the present invention.

FIG. 53 is a perspective view showing the exploded components of a magnetic drive device of the touch spray head according to the fifth embodiment of the present invention.

FIG. 54 is another perspective view showing the exploded components of the magnetic drive device of the touch spray head according to the fifth embodiment of the present invention.

FIG. 55 is a cross sectional view showing the operation of the touch spray head according to the fifth embodiment of the present invention.

FIG. 56 is a perspective view showing the exploded components of a part of the touch spray head according to the first, second, third, fourth, and fifth embodiments of the present invention respectively.

### DETAILED DESCRIPTION OF THE PREFERRED EMBODIMENTS

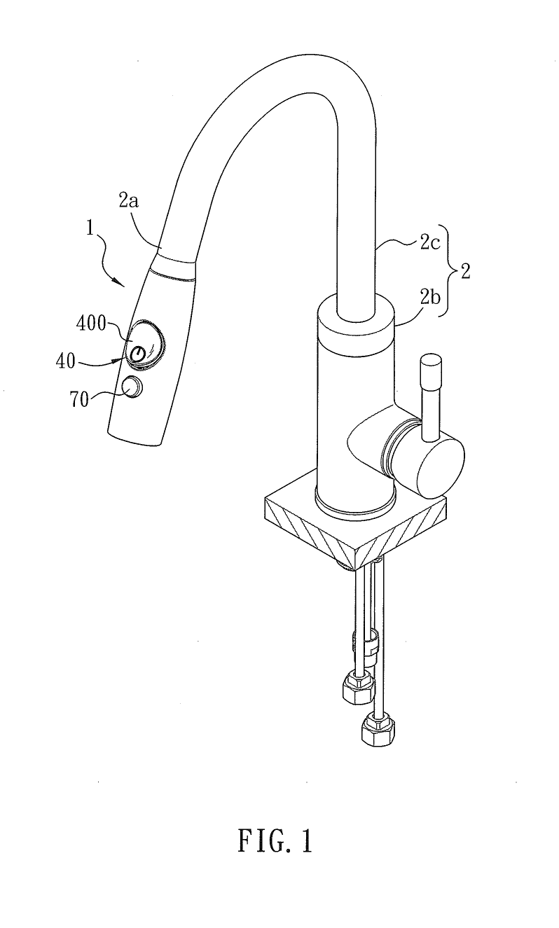

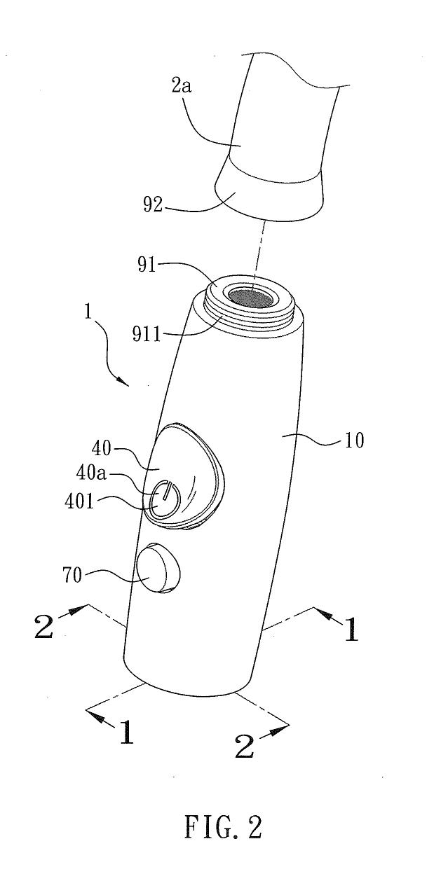

With reference to FIGS. 1 and 2, a touch spray head 1 according to a preferred embodiment of the present invention is mounted on a faucet which is fixed in a kitchen or a bathroom. The touch spray head 1 is removably connected on an outlet 2a of a faucet body 2, and the faucet body 2 includes a holder 2b and an outflow tube 2c extending windingly from a top of the holder 2b, wherein the outlet 2a defines on a distal end of the outflow tube 2c.

The touch spray head 1 includes a casing 10, a fixing cylinder 20, a water valve 30, and a manual operation device 40.

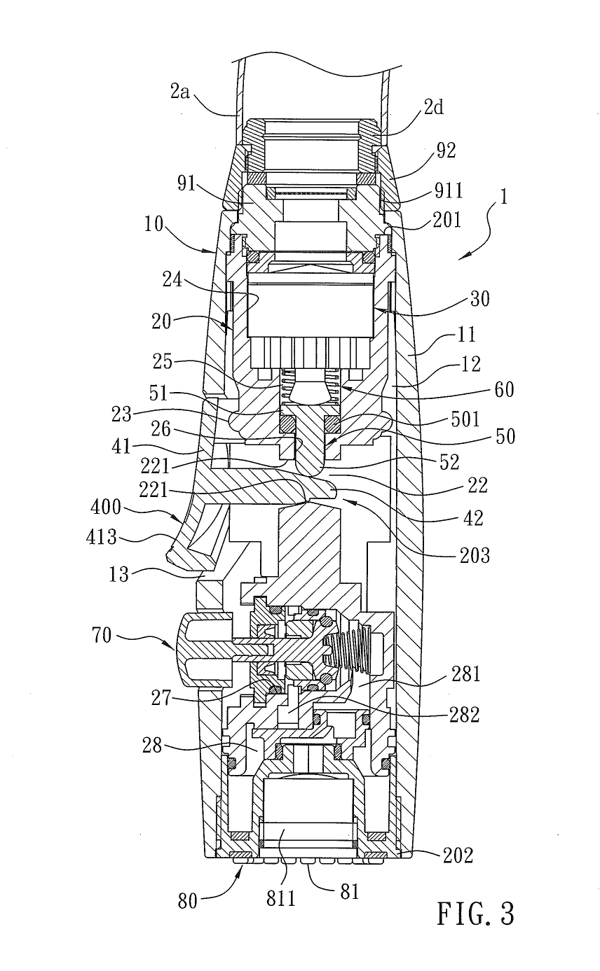

Referring to FIGS. 3-5, the casing 10 includes a surrounding fence 11, an accommodation space 12 defined inside the surrounding fence 11, and a through hole 13 formed on the surrounding fence 11 and communicating with the accommodation space 12.

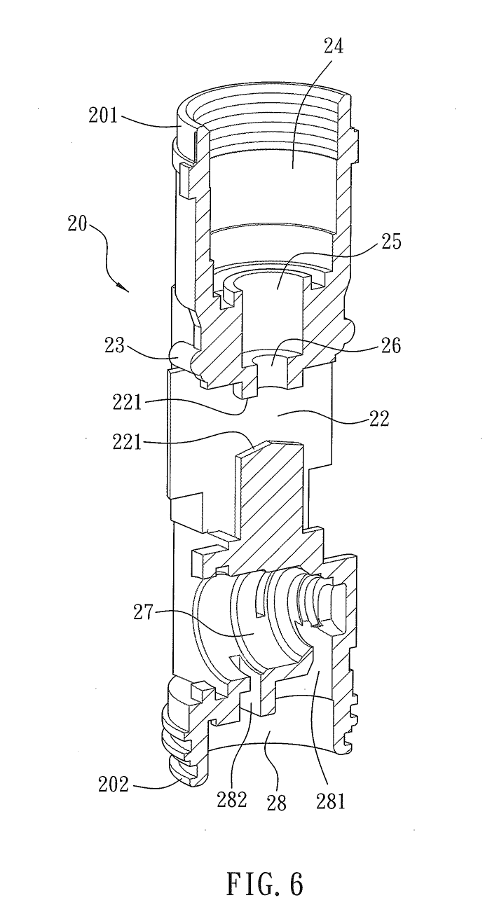

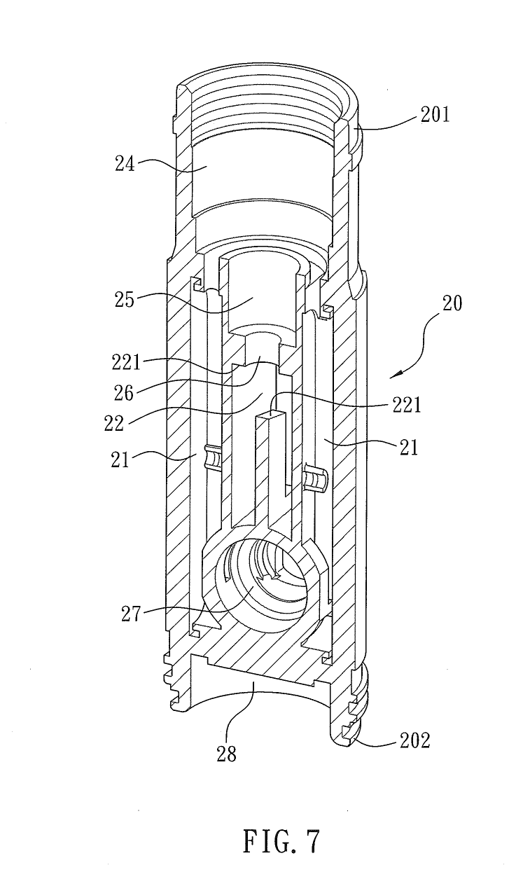

As shown in FIGS. 6 and 7, the fixing cylinder 20 is housed in the accommodation space 12 of the casing 10 and includes an inlet segment 201 communicating with the outlet 2a of the faucet body 2, an outlet segment 202, at least one first orifice 21 defined between the inlet segment 201 and the outlet segment 202, and a receiving zone 203.

The water valve 30 is accommodated in the fixing cylinder 20 and includes an operation bar 31 touched to movably turn on the water valve 30 so that the water flows into the at least one first orifice 21 of the fixing cylinder 20 from the outlet 2a of the faucet body 2.

The manual operation device 40 is housed in the receiving zone 203 of the fixing cylinder 20 and the through hole 13 of the casing 10, and the manual operation device 40 includes a driving portion 40a formed in the through hole 13 so as to be driven by user to actuate the operation bar 31 of the water valve 30 to move.

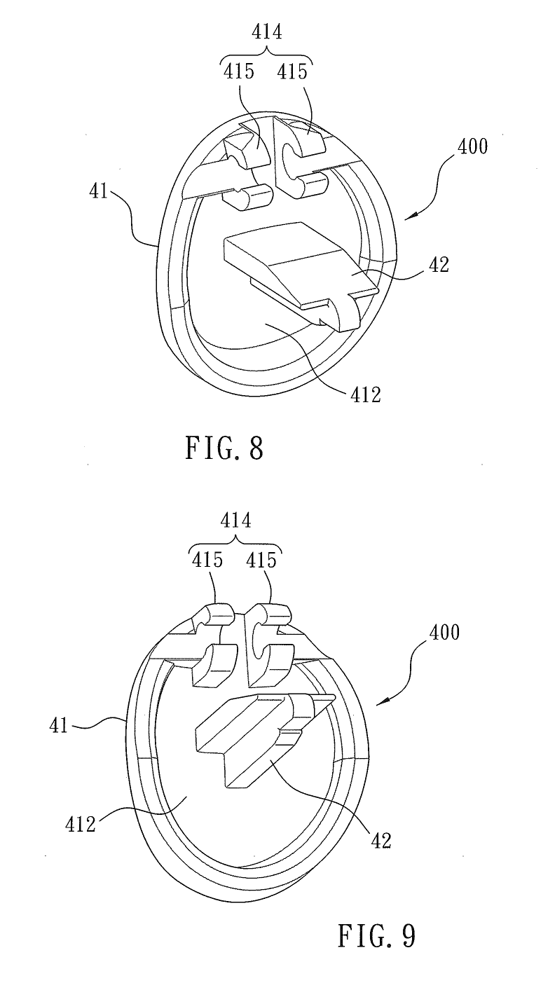

In this embodiment, the fixing cylinder 20 further includes a second orifice 22 formed in the receiving zone 203 and includes a first connection portion 23. The manual operation device 40 includes a pressing button 400 which has a force portion 41 and a drive stem 42 extending from the force portion 41. As shown in FIGS. 8 and 9, a part of the drive stem 42 is limited in the second orifice 22 of the fixing cylinder 20; the force portion 41 has an external face 411 and an internal face 412, wherein the external face 411 has an operating zone 413 configured to form the driving portion 40a, the internal face 412 has a second connection portion 414 rotatably connected with the first connection portion 23, hence when the operating zone 413 is pressed, the drive stem 42 in the second orifice 22 touches the operation bar 31 of the water valve 30 to move by way of the first connection portion 23 and the second connection portion 414.

The fixing cylinder 20 further includes a receiving cavity 24 located on the inlet segment 201, a groove 25 formed in a bottom of the receiving cavity 24, and a third orifice 26 passing through a bottom of the groove 25, wherein the at least one first orifice 21 communicates with the receiving cavity 24 and the outlet segment 202. The water valve 30 is accommodated in the receiving cavity 24, and the operation bar 31 is housed in the groove 25.

With reference to FIGS. 3-5, the touch spray head 1 further includes a push column 50 extending out of the groove 25 from the third orifice 26 and configured to push the drive stem 42 of the pressing button 400 to actuate the operation bar 31.

In this embodiment, the operating zone 413 of the pressing button 400 is touched by the user via the through hole 13 of the casing 10, as illustrated in FIG. 3. Preferably, a size of the through hole 13 is more than the force portion 41 of the pressing button 400 so that the force portion 41 is accommodated in the through hole 13, and the operating zone 413 of the force portion 41 exposes outside so that the user presses the operating zone 413.

In this embodiment, the first connection portion 23 of the fixing cylinder 20 is at least one rotary shaft; the second connection portion 414 of the pressing button 400 is at least one rotatable tab 415 configured to retain with the at least one rotary shaft. For example, the first connection portion 23 is a rotary shaft, and the second connection portion 414 is two rotatable tabs retained with the rotary shaft.

Alternatively, the first connection portion 23 of the fixing cylinder 20 is at least one rotatable tab, and the second connection portion 414 of the pressing button 400 is at least one rotary shaft retained with the at least one rotatable tab.

The push column 50 includes a fitting portion 51 sliding upward and downward in the groove 25, and the push column 50 includes an extension 52 extending out of the third orifice 26 from the fitting portion 51. The fitting portion 51 is configured to drive the operation bar 31 of the water valve 30. A distal end of the extension 52 is driven by the drive stem 42 of the pressing button 400.

Referring to FIGS. 3-5, the touch spray head 1 further comprises a compression spring 60 accommodated in the groove 25 between the water valve 30 and the fitting portion 51 of the push column 50 so that the push column 50 and the pressing button 400 are pushed by the compressing spring 60 to move back to original positions respectively.

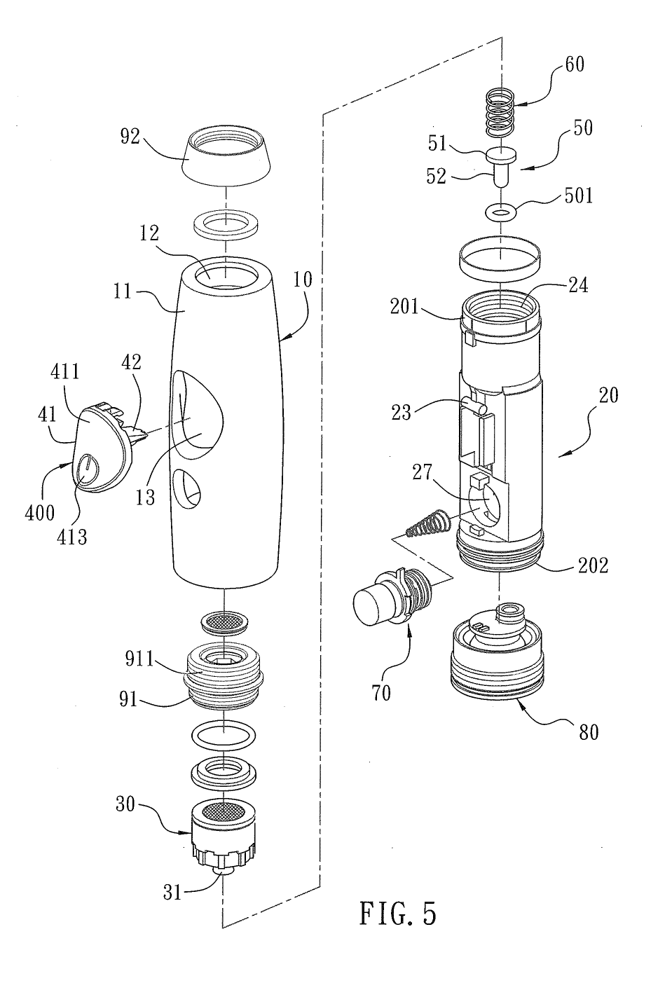

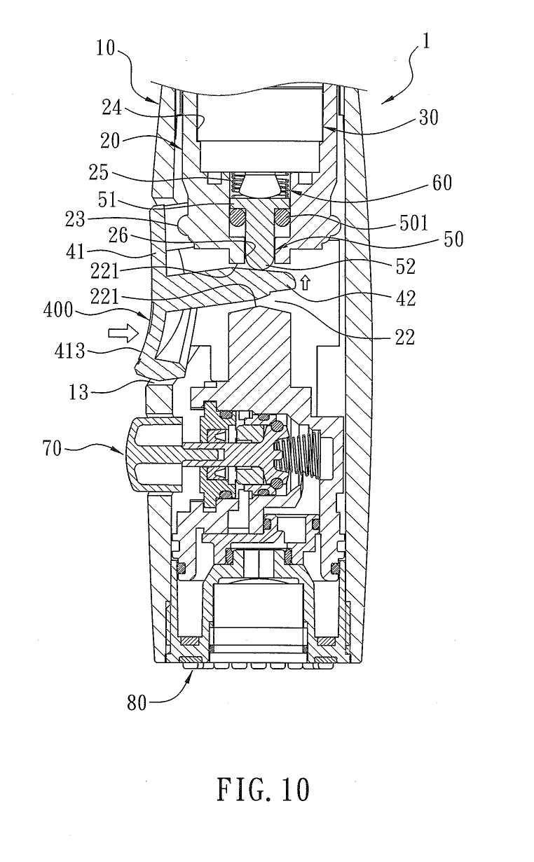

In this embodiment, the second orifice 22 of the fixing cylinder 20 has two opposite limiting fringes 221 defined therein so that when the drive stem 42 of the pressing button 400 is pressed and released, the drive stem 42 moves between the two opposite limiting fringes 221. The second connection portion 414 of the pressing button 400 is opposite to the operating zone 413 of the pressing button 400. As shown in FIG. 3, when the pressing button 400 is not pressed, the operating zone 413 extends out of the through hole 13 of the casing 10 so as to be pressed by the user easily. Preferably, an on/off pattern arranged on the operating zone 413, as illustrated in FIG. 5. When the operating zone 413 of the pressing button 400 is pressed, the pressing button 400 rotates in the through hole 13 so that the drive stem 42 removes from a lower one of the two limiting fringes 221 to swing upward, hence the push column 50 is pushed upwardly by the drive stem 42 so as to drive the operation bar 31 to turn on the water valve 30, thus flowing the water, as illustrated in FIG. 10.

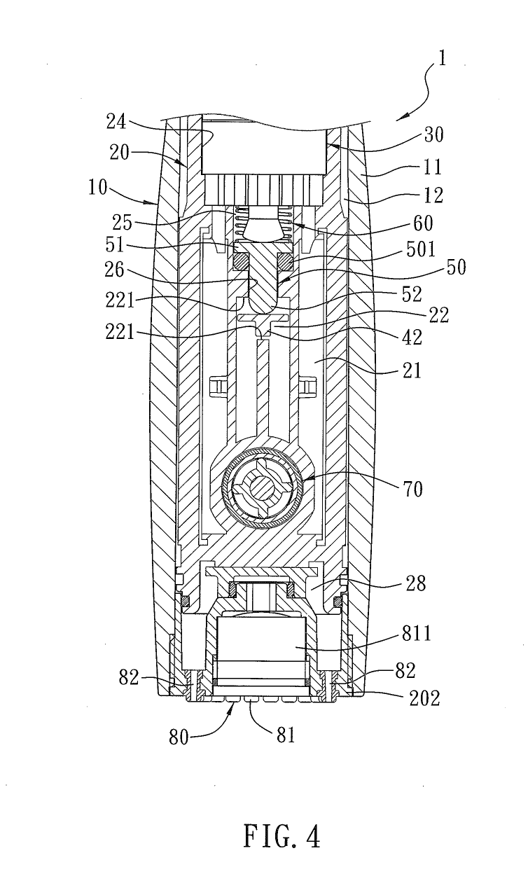

In this embodiment, the extension 52 of the push column 50 has a seal washer 501 fitted thereon and contacting with the groove 25 so as to avoid water leakage out of the third orifice 26 from the groove 25, as illustrated in FIGS. 3 and 4.

The touch spray head 1 further comprises a switch valve assembly 70 arranged on the fixing cylinder 20 and configured to switch to water spraying mode, and the touch spray head 1 comprises a water spray set 80, as shown in FIGS. 3 and 4. The switch valve assembly 70 is pressed so as to guide the water to the water spray set 80 from the at least one first orifice 21, thus producing at least two water spraying modes, such as a central spraying mode and a peripheral spraying mode.

With reference to FIGS. 6 and 7, the fixing cylinder 20 includes a first trench 27 communicating with the at least one first one orifice 21 so as to fix the switch valve assembly 70 in the first trench 27. The fixing cylinder 20 further includes a second trench 28 for accommodating the water spray set 80, wherein the second trench 28 has a central channel 281 and a peripheral channel 282 communicating with the first trench 27. The water spray set 80 includes a first aperture 81 communicating with the central channel 281 so as to spray the water out of the first aperture 81 in the central spraying mode, and the water spray set 80 includes multiple second apertures 82 communicating with the peripheral channel 282 so as to spray the water from the multiple second apertures 82 in the peripheral spraying mode. The first aperture 81 includes a bubble generator 811 so as to produce bubble water.

The fixing cylinder 20 matches with a water sprayer so as to spray the water from the at least one first orifice 21 in the water spraying mode.

Referring to FIGS. 3-5, the touch spray head 1 further comprises an inflow connector 91 screwed in a top of the receiving cavity 24, and the inflow connector 91 has a threaded connecting portion 911 extending out of a top of the casing 10, a screw sleeve 92 formed on the outlet 2a of the faucet body 2 and screwing with the threaded connecting portion 911. The outlet 2a has a coupling seat 2d welded therein, wherein the coupling seat 2d has outer threads formed thereon so as to screw with inner threads of the screw sleeve 92.

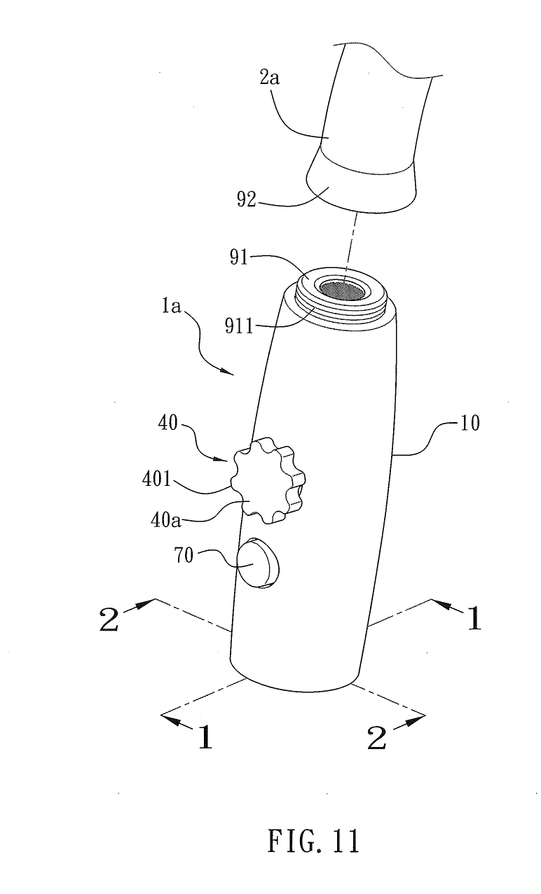

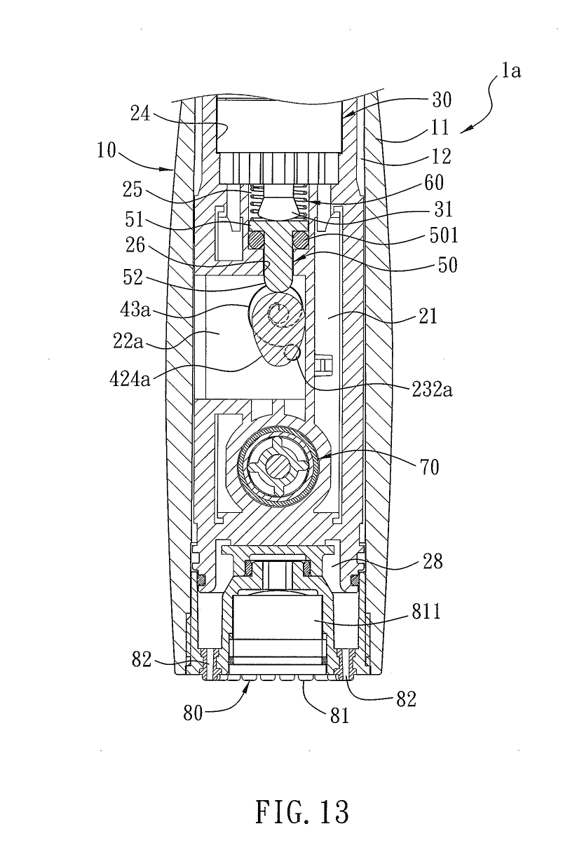

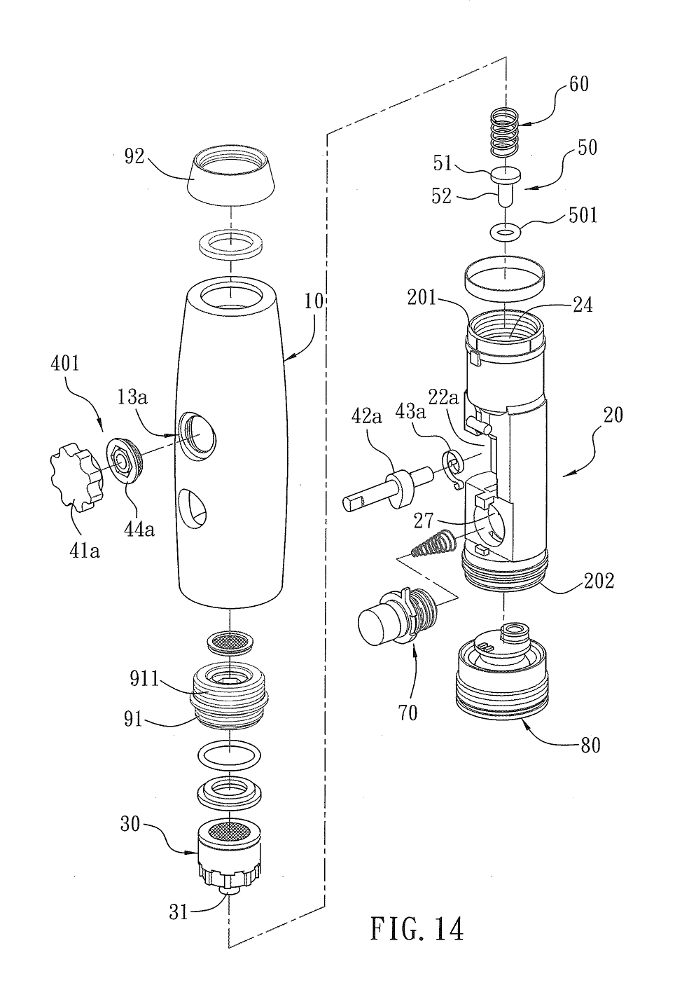

With reference to FIGS. 11-14, a difference of a touch spray head 1a of a second embodiment from that of the first embodiment comprises:

a housing portion 13a formed on the surrounding fence 11 of the casing 10 and communicating with the accommodation space 12, and the housing portion 13a has the through hole 13.

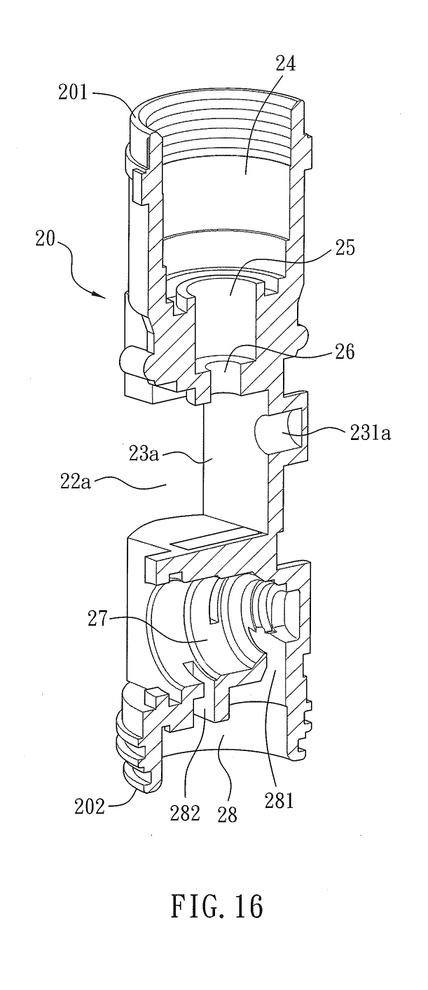

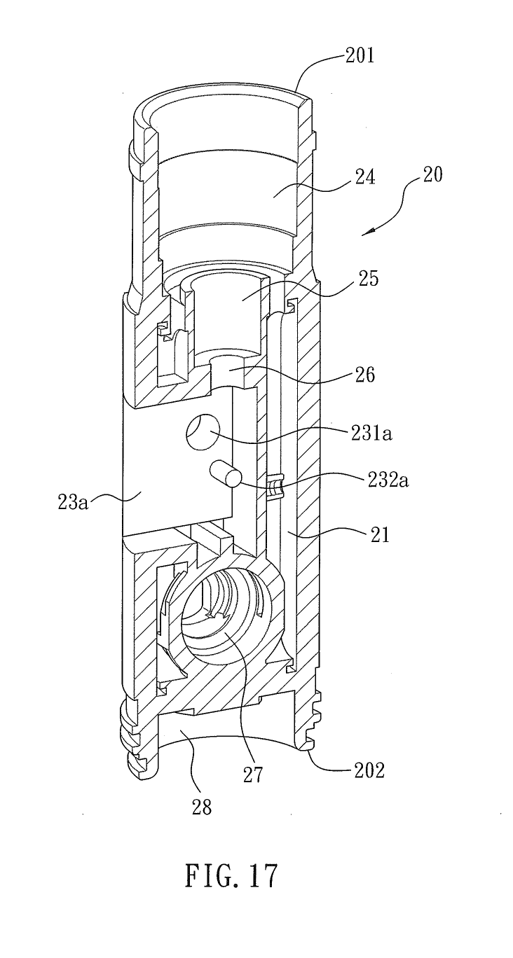

Referring to FIGS. 16 and 17, the receiving zone 203 of the fixing cylinder 20 has a first notch 22a formed therein; a peripheral fence 23a of the first notch 22a has a connection portion 231a and an affix portion 232a. In this embodiment, the connection portion 231a is a connection hole.

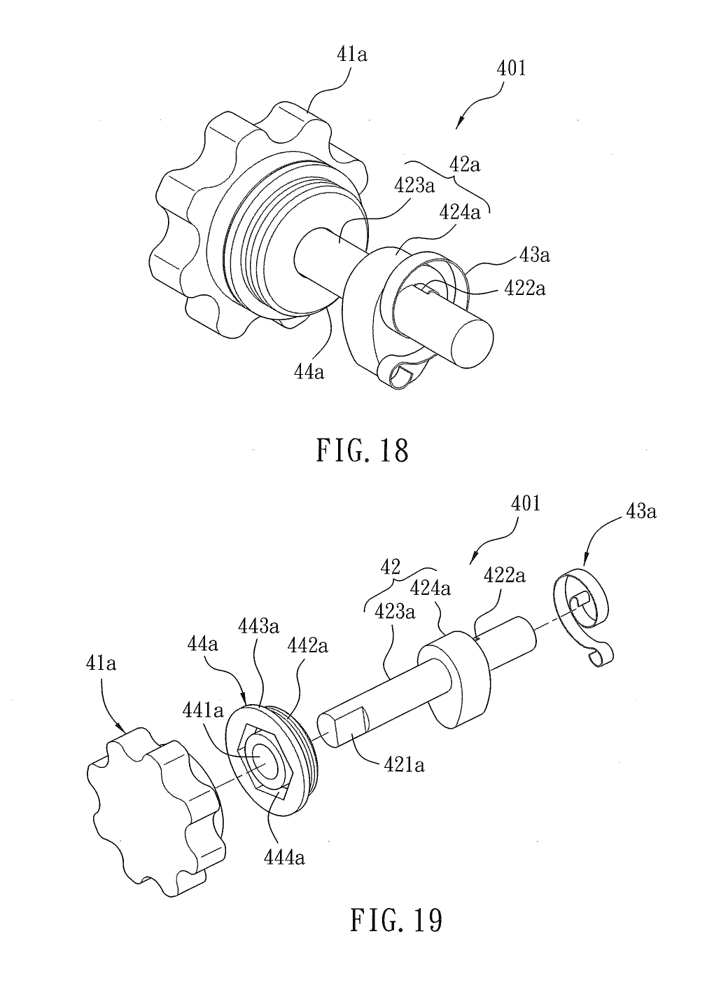

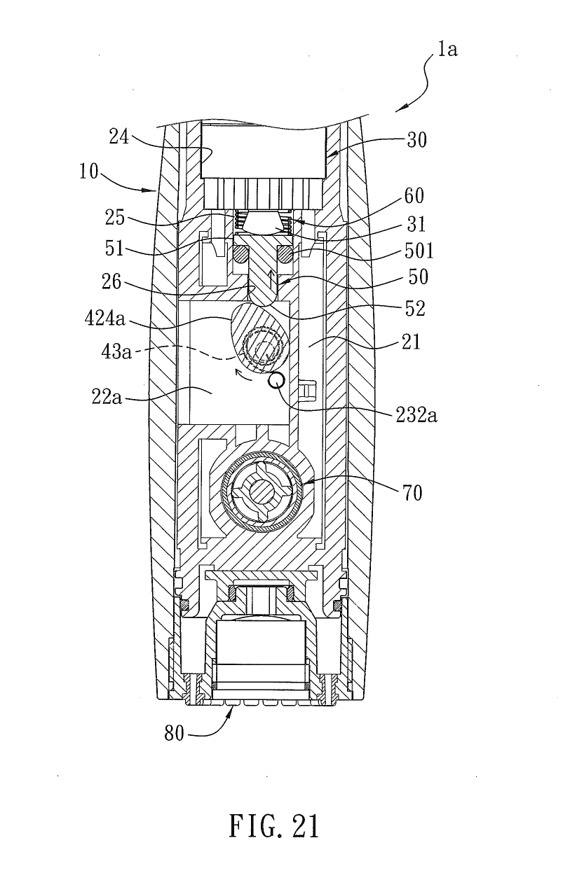

Referring to FIGS. 18-20, the manual operation device 40 is a rotation device 401 housed in the housing portion 13a of the casing 10, and the rotation device 40 includes a rotatable knob 41a rotated by the user and a drive member 42a; a part of the drive member 42a is accommodated in the first notch 22a of the fixing cylinder 20; the drive member 42a has a rotary shaft 423a and a cam 424a located on the rotary shaft 423a, wherein a first end of the rotary shaft 423a couples with the rotatable knob 41a, and a second end of the rotary shaft 423a rotatably connects with the connection portion 231a of the fixing cylinder 20. The rotation device 40 further includes a coil spring 43a, a first end of which connects with the drive member 42a, and a second end of the coil spring 43a couples with the affix portion 232a of the fixing cylinder 20. The rotatable knob 41a is rotated by the user to drive the drive member 42a to rotate so that the cam 424a of the drive member 42a actuates the operation bar 31 of the water valve 30 to move, as shown in FIG. 21, and the coil spring 43a is tightened, hence after the cam 424a and rotatable knob 41a are released, the coil spring 43a returns to an original position.

In addition, the cam 424a of the rotation device 401 actuates the operation bar 31 via the push column 50.

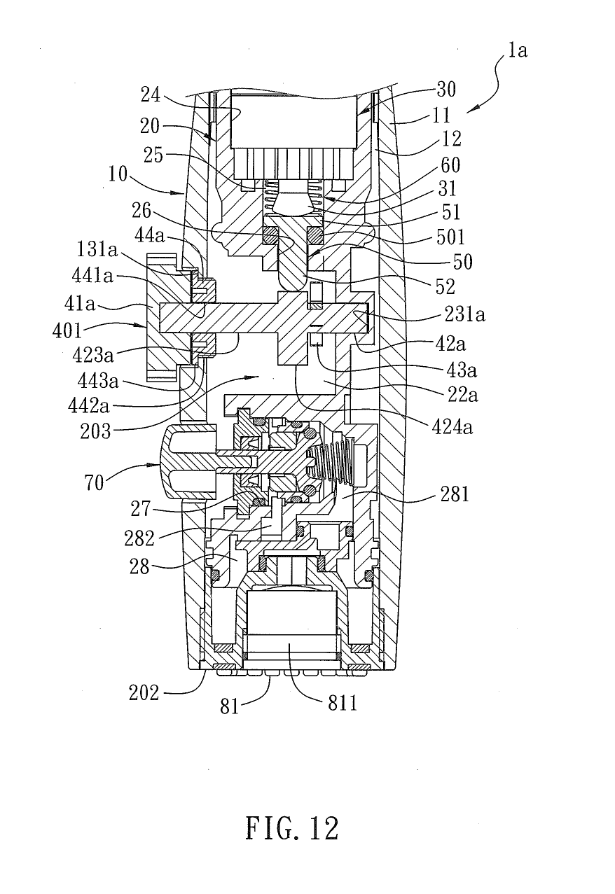

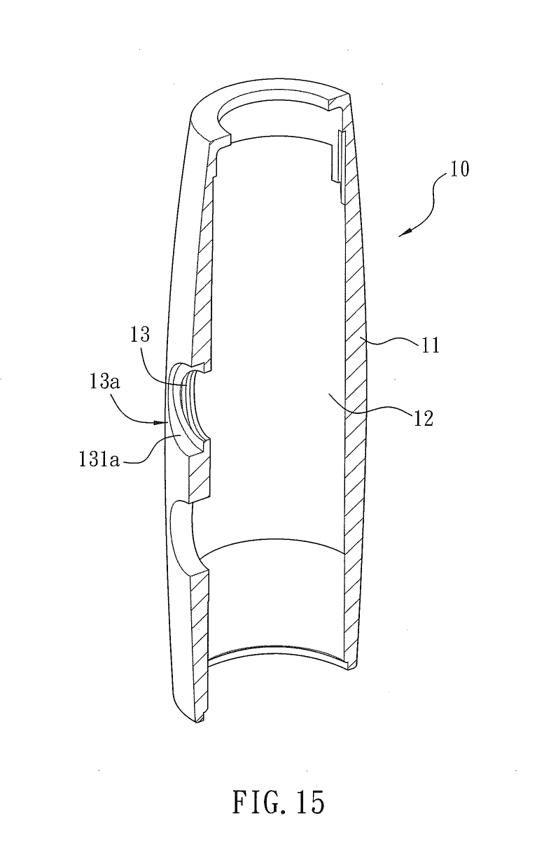

With reference to FIG. 15, the housing portion 13a of the casing 10 has a recess 131a and has the through hole 13 formed in a bottom of the recess 131a, wherein the through hole 13 is a screwing hole communicating with the accommodation space 12 of the casing 10. Referring to FIGS. 18-20, the rotation device 401 further includes a holding seat 44a screwing with the screwing hole 13, as shown in FIG. 12, and the holding seat 44 has a coupling opening 441a so that the first end of the rotary shaft 423a rotatably couples with the rotatable knob 41a via the coupling opening 441a.

The holding seat 44a has a first threaded portion 442a arranged on an outer wall thereof and a defining fence 443a extending outward from the first threaded portion 442a, hence the first threaded portion 442a screws with the screwing hole 13, and the defining fence 443a abuts against the bottom of the recess 131a. The holding seat 44a has a first non-circular slot 444a defined on an outer edge thereof, and the first non-circular slot 444a is hexagonal so that a rotation tool retains in the first non-circular slot 444a and screws the holding seat 44a with the screwing hole 13.

The rotatable knob 41a has a second non-circular slot 411a formed in an inner wall thereof, and the second non-circular slot 411a is semicircular or is in a D shape. The rotary shaft 423a of the drive member 42a has a non-circular connector 421a formed on an outer end thereof so that the non-circular connector 421a retains in the second non-circular slot 411a to connect the rotatable knob 41a and the drive member 42a together.

In this embodiment, the cam 424a of the drive member 42a is one-piece formed on the rotary shaft 423a. In another embodiment, the cam 424a and the rotary shaft 423a are connected together in a welding manner or in a fitting manner.

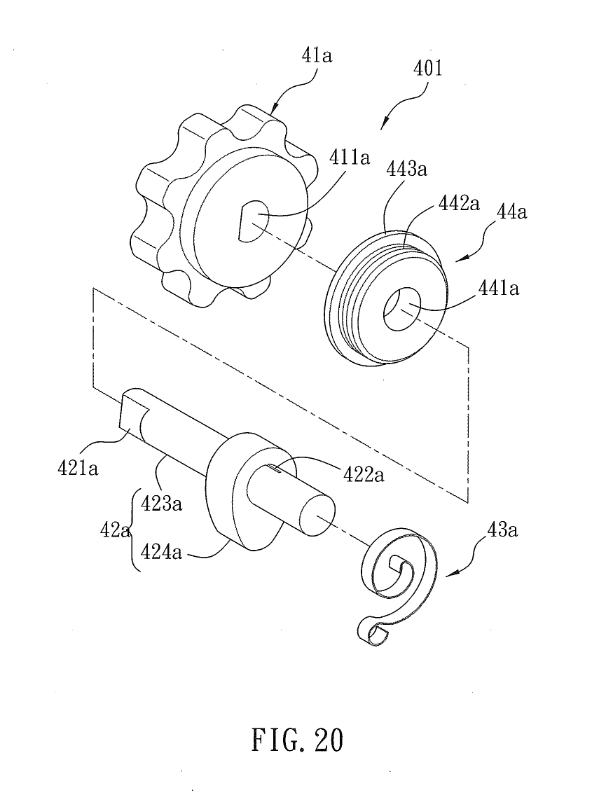

As illustrated in FIG. 20, the drive member 42a has a second notch 422a defined on one end thereof adjacent to the cam 424a. With reference to FIGS. 17 and 18, a first fitting portion 232a of the fixing cylinder 20 is a post so that the coil spring 43a fits on the rotary shaft 423a and a first end of the coil spring 43a fixes in the second notch 422a, a second end of the coil spring 43a fits on the first fitting portion 232a. Referring to FIG. 11, when the drive member 42a revolves clockwise, the coil spring 43a twists tightly and forces the drive member 42a, hence the rotatable knob 41a and the drive member 42a move back to original positions respectively. In other words, the cam 424ab removes from the push column 50.

In this embodiment, a distal end of the extension 52 of the push column 50 is driven by the cam 424a of the rotation device 401.

As illustrated in FIGS. 12-14, the touch spray head 1 further comprises a compression spring 60 configured to push the push column 50 to move back to an original position, after releasing the rotation device 401. After the rotation device 401 is released, the rotatable knob 41a and the drive member 42a are pushed by the coil spring 43a to move back to the original positions individually, hence the cam 424a removes from the extension 52 of the push column 50, and the push column 50 is pushed by the compression spring 60 to downward moves back to an original position so that the extension 52 moves back to an original position.

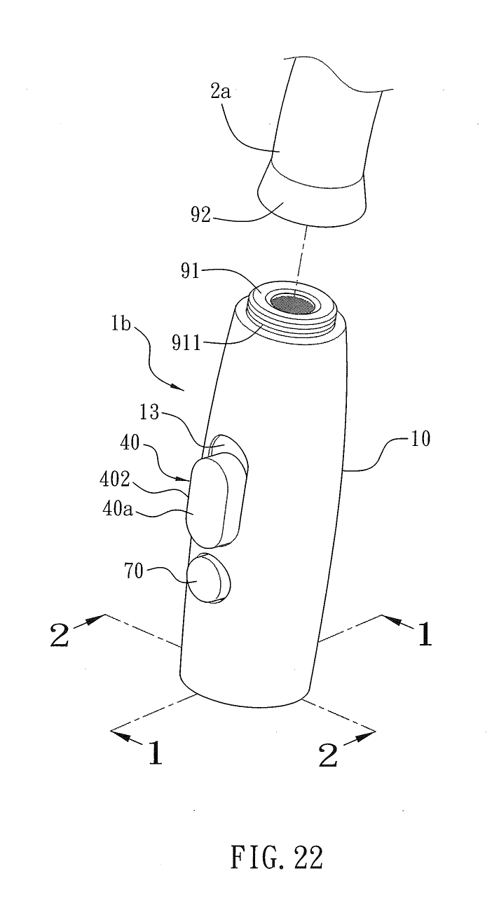

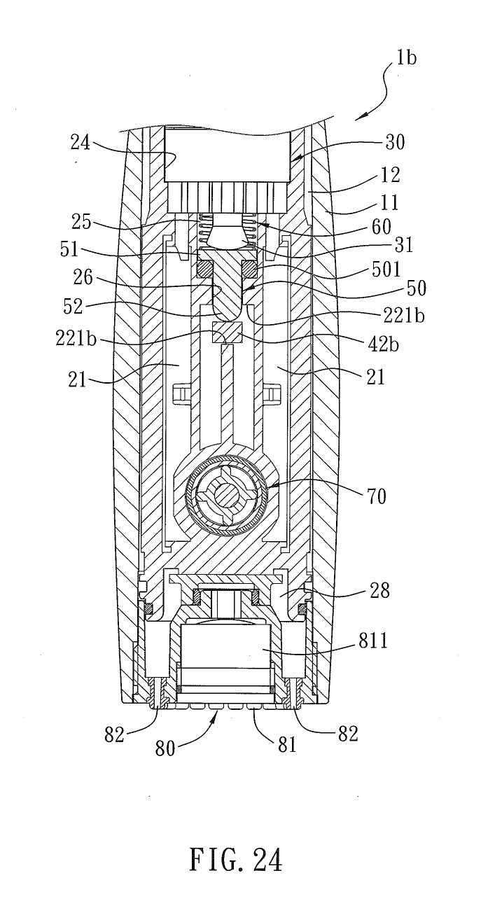

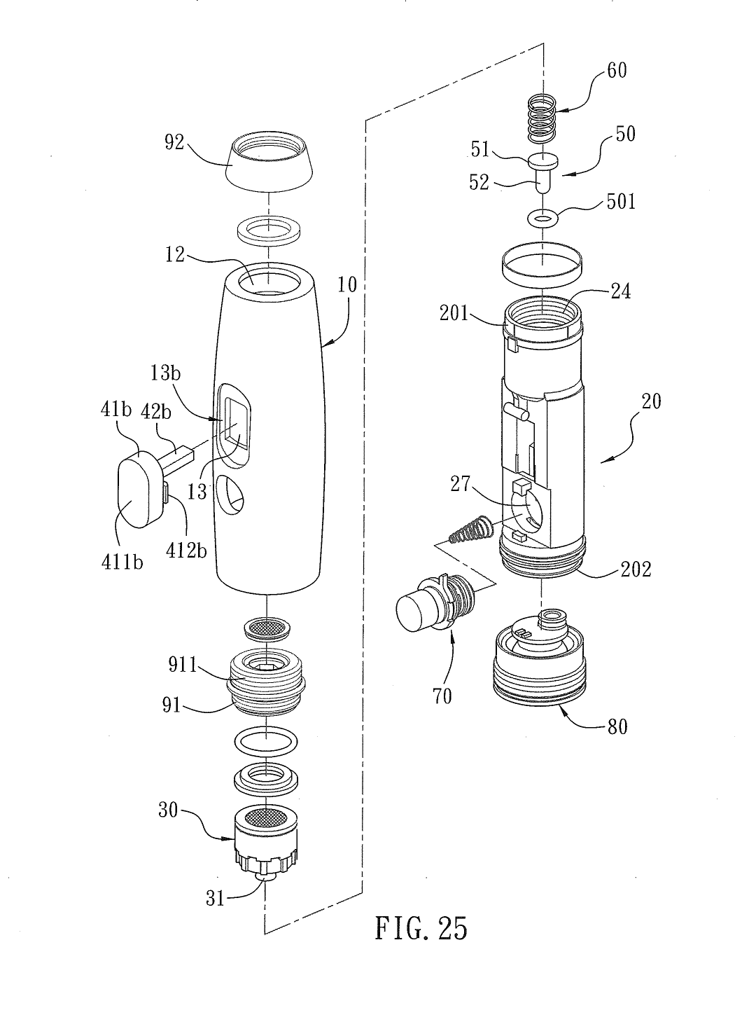

With reference to FIGS. 22-25, a difference of a touch spray head 1b of a third embodiment from that of the first embodiment comprises:

the surrounding fence 11 of the casing 10 having a positioning portion 13b formed thereon, wherein the positioning portion 13b has the through hole 13 communicating with the accommodation space 12.

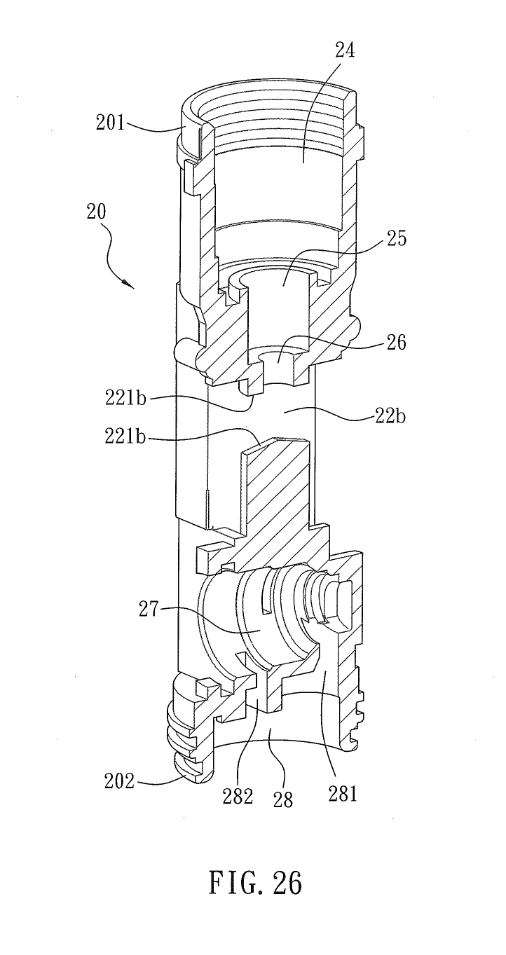

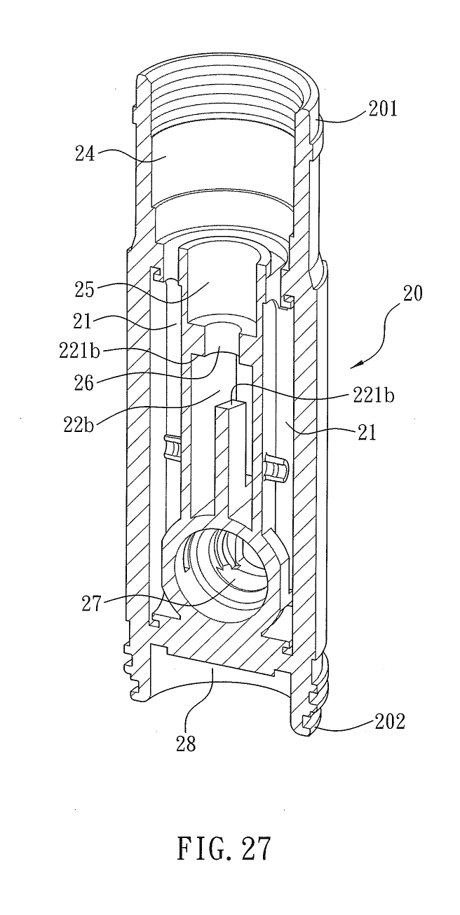

Referring to FIGS. 26-27, the fixing cylinder 20 further includes a second orifice 22b formed in the receiving zone 203.

The manual operation device 40 is a pushing button 402 sliding within a predetermined distance on the positioning portion 13b, and the pushing button 402 includes a movable portion 41b and a drive stem 42b extending from the movable portion 41b; a part of the drive stem 42b is limited in the second orifice 22b of the fixing cylinder 20, and the drive stem 42b is pushed to move on the movable portion 41b of the pushing button 402 along the positioning portion 13b so as to drive the operation bar 31 of the water valve 30 to move.

In addition, the drive stem 42b of the pushing button 402 actuates the operation bar 31 via the push column 50.

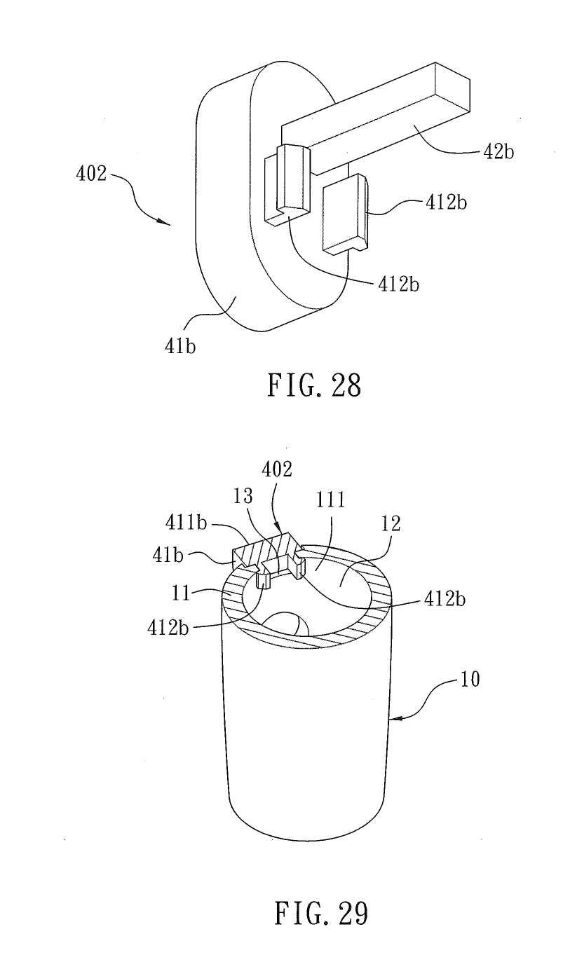

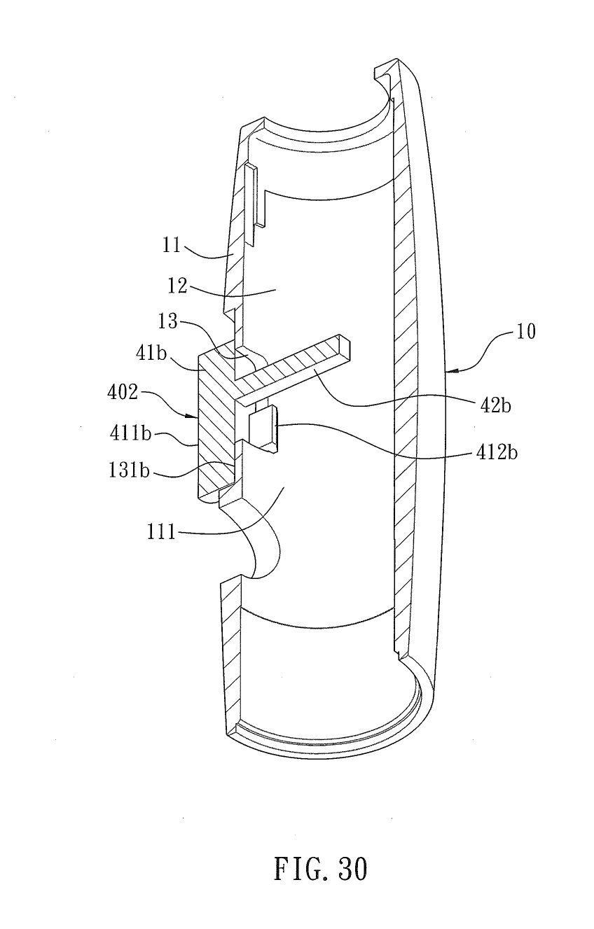

As shown in FIGS. 28-30, the positioning portion 13b of the casing 10 has a first trench 131b in which the movable portion 41b of the pushing button 402 slidably retains and moves. The movable portion 41b has an external face 411b configured to form the driving portion 40a, and the movable portion 41b has two flexible hooks 412b extending into the casing 10 from the external face 411b, wherein the two flexible hooks 412 respectively hook with two opposite ends of an internal fence 111 of the casing 10 via the through hole 13 of the casing 10.

The pushing button 402 is pushed upwardly by the user along the fixing cylinder 20.

In this embodiment, a distal end of the extension 52 of the push column 50 is driven by the drive stem 42b of the pushing button 402.

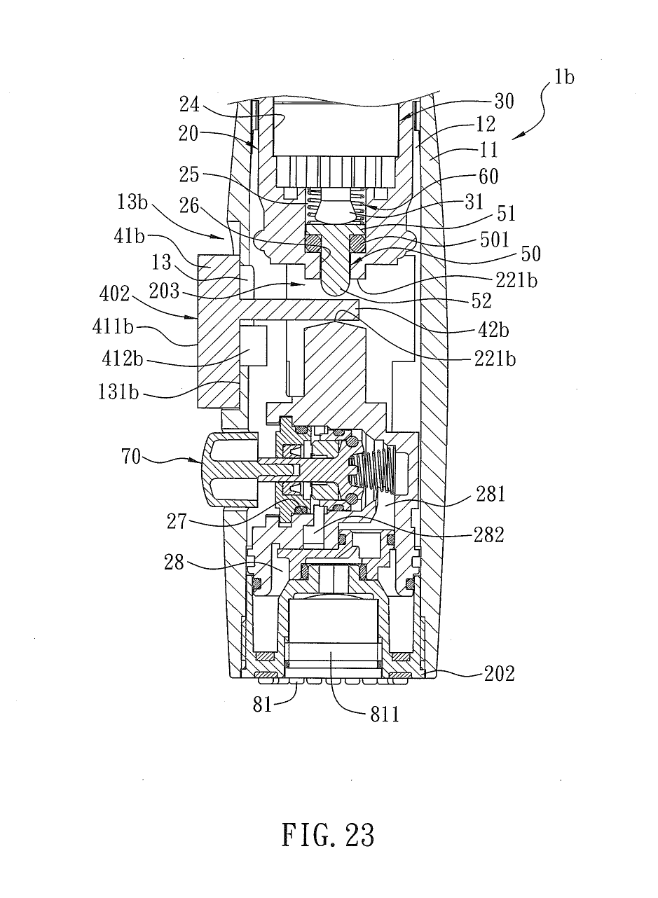

Referring to FIGS. 23-25, the touch spray head 1 further comprises a compression spring 60 configured to push the push column 50 and the pushing button 402 to move back to original positions respectively after releasing the pushing button 402. In other words, an elasticity of the compression spring 60 acts on the push column 50 so that the push column 50 downward pushes against the drive stem 42b of the pushing button 402, hence the pushing button 402 moves back to an original position.

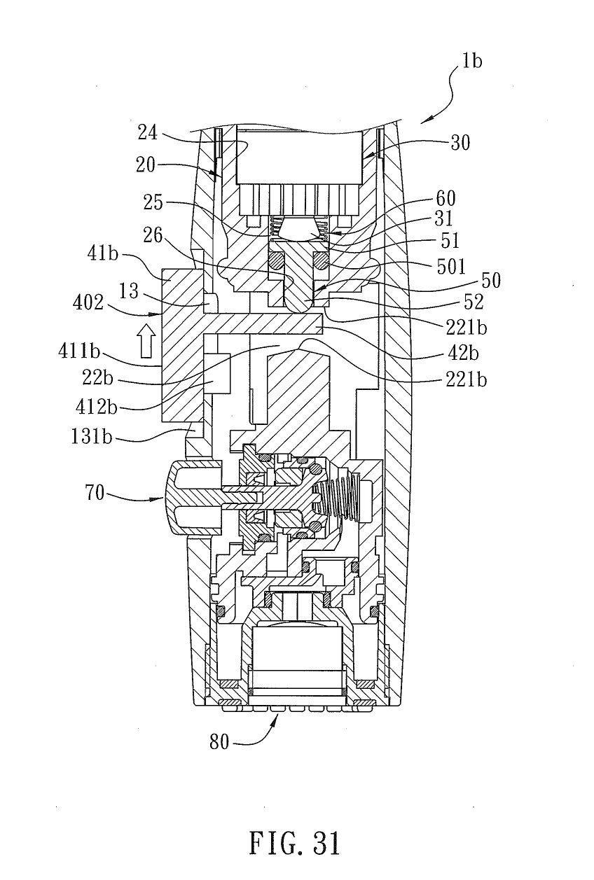

As illustrated in FIGS. 23 and 31, the second orifice 22b of the fixing cylinder 20 has two opposite limiting fringes 221b formed therein so that the drive stem 42b of the pushing button 402 moves between the two opposite limiting fences 221 after pushing and releasing the pushing button 402. When the pushing button 402 is not pushed, it is located on a bottom of the first trench 131b; when the external face 411b of the pushing button 402 is pushed upward, the pushing button 402 moves upward along the first trench 131b of the positioning portion 1b so that the drive stem 42b upward removes from the two opposite limiting fences 221b to push the push column 50 upward, and the push column 50 touches the operation bar 31 of the water valve 30, thus starting water supply, as shown in FIG. 31.

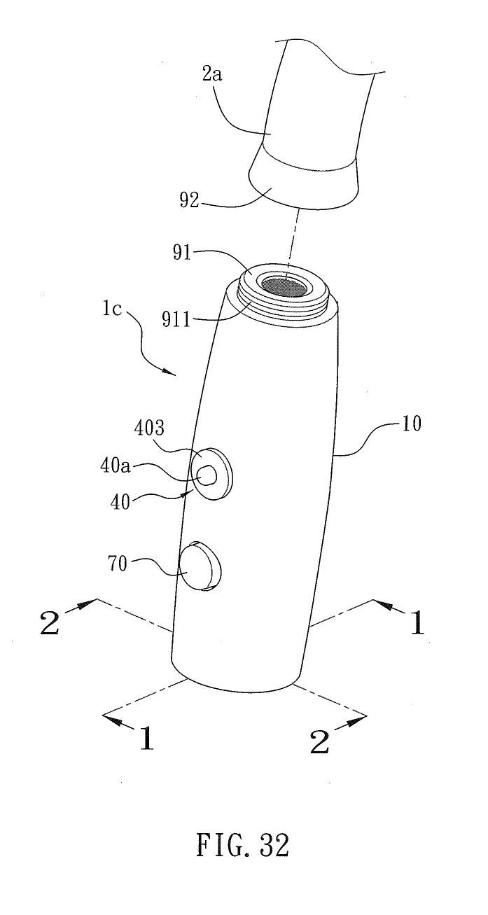

With reference to FIGS. 32-35, a difference of a touch spray head 1c of a fourth embodiment from that of the first embodiment comprises:

an accommodating chamber 22c formed in the receiving zone 203 of the fixing cylinder 20; the accommodating chamber 22c having a first opening 231c formed on a peripheral fence 23c of the accommodating chamber 22c.

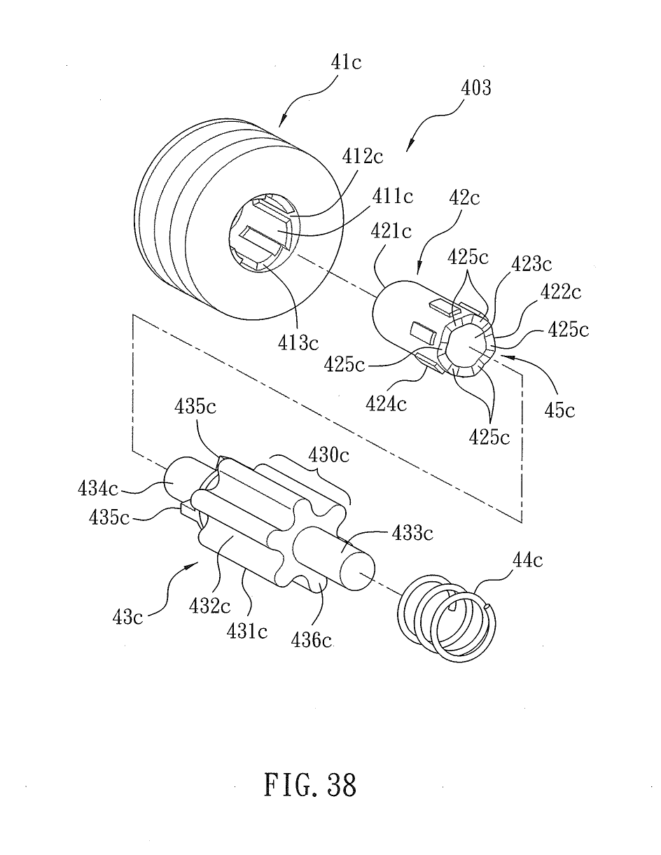

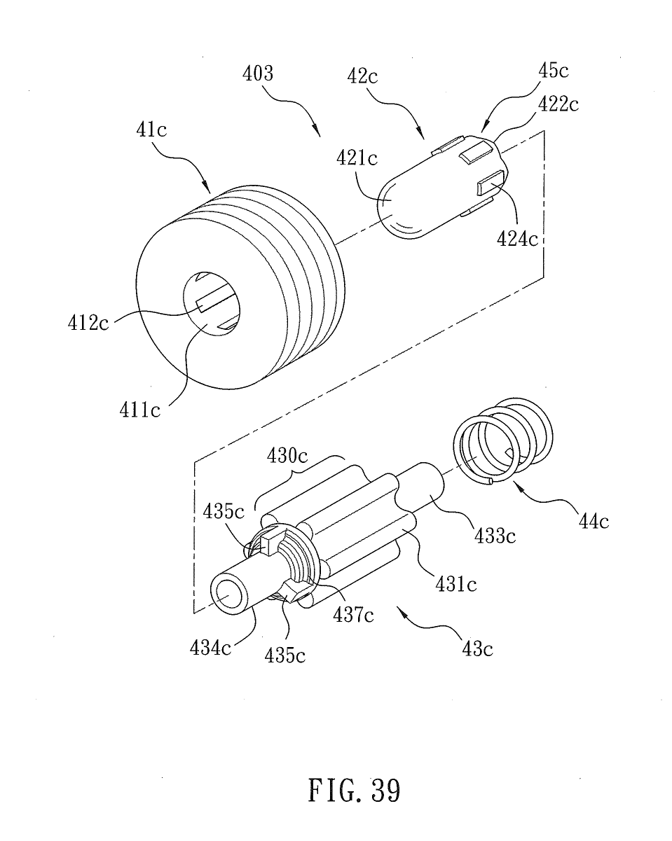

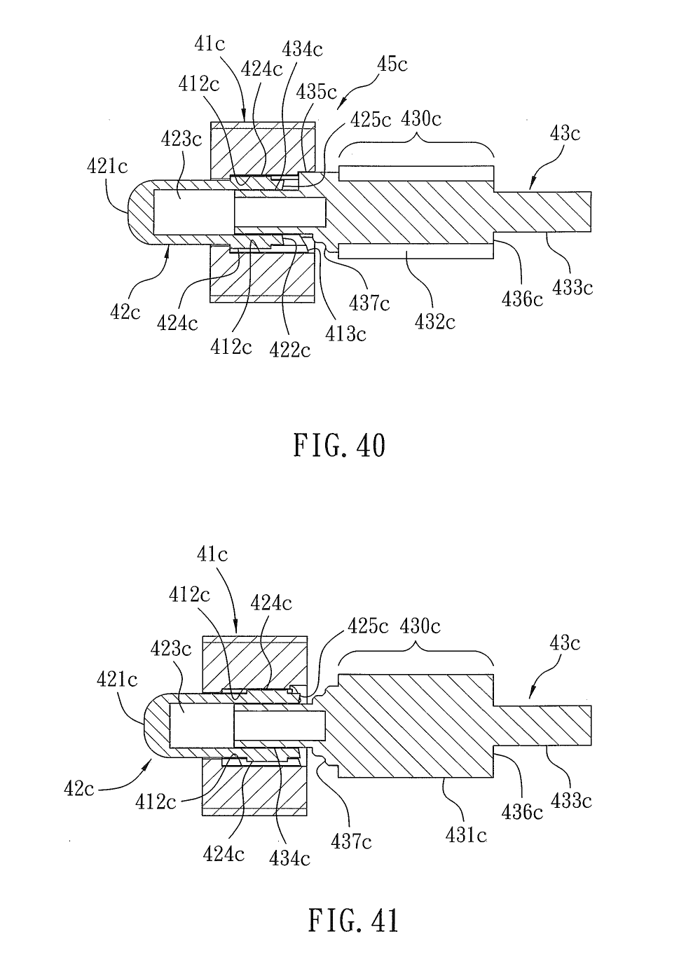

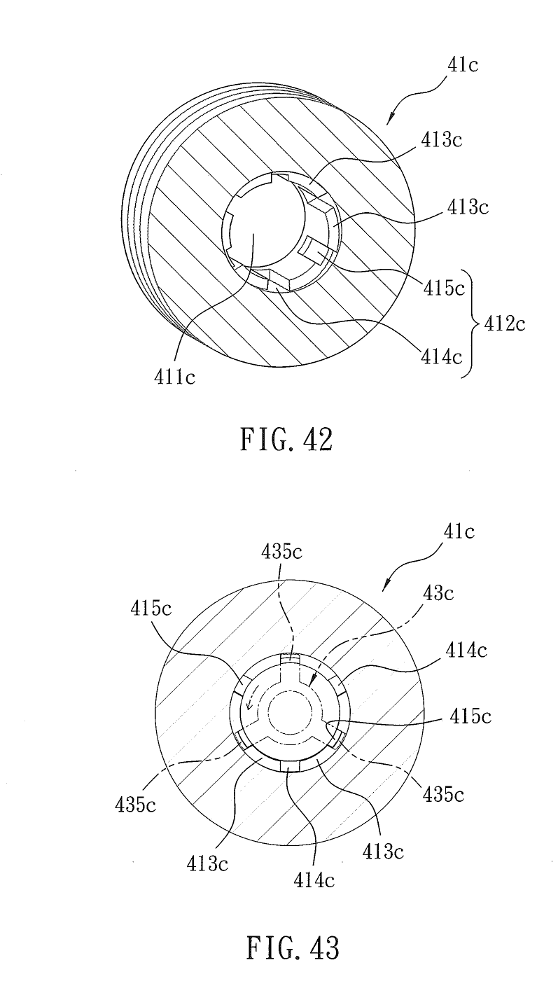

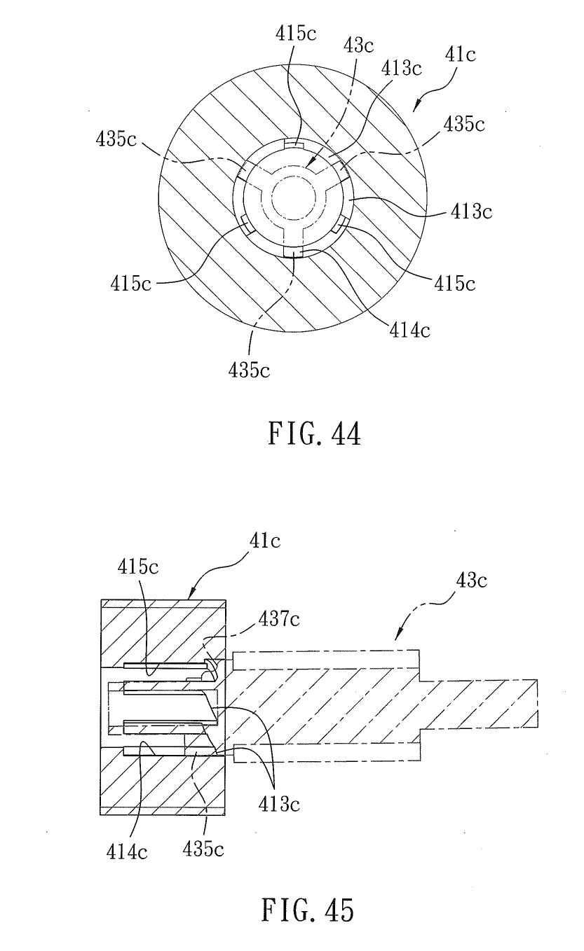

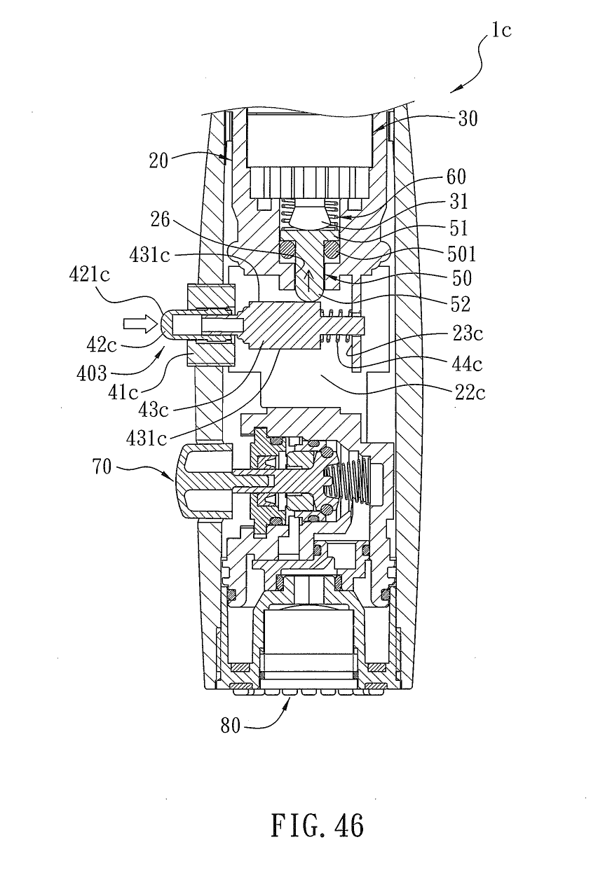

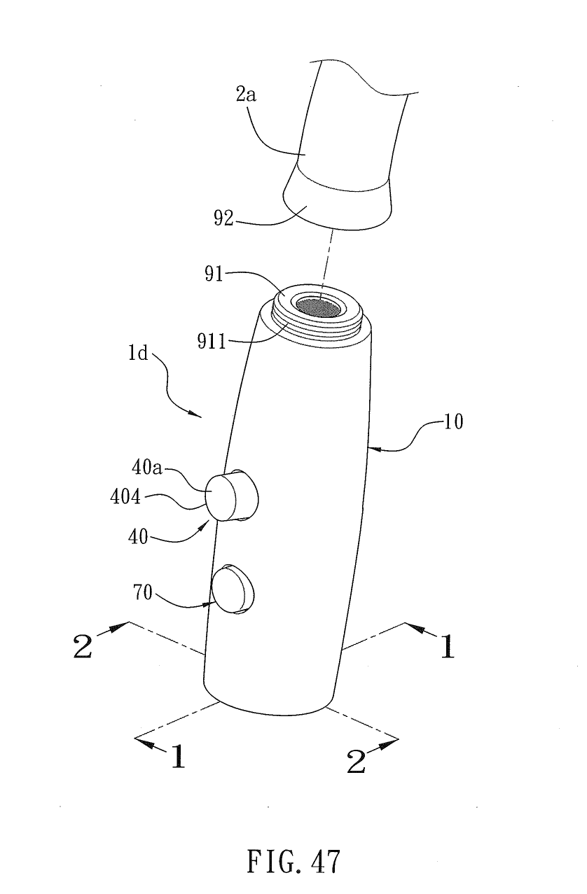

As shown in FIGS. 38-41, the manual operation device 40 is a rotation device 403, and the rotation device 403 includes a tubular part 41c accommodated in the through hole 13; a press member 42c fitted in the tubular part 41c, wherein the press member 42c has a force exerting segment 421c configured to form the driving portion 40a, an abutting segment 422c, a second opening 423c defined in the press member 42c; a rotating member 43c rotatably connected with the first opening 231c of the fixing cylinder 20 and the second opening 423c of the press member 42c, wherein the rotating member 43c has an action zone 430c formed on an outer wall thereof, and the action zone 430c has multiple acting portions 431c and multiple non-acting portions 432c which are spaced from one another by the multiple acting portions 431 respectively, wherein the multiple acting portions 431c are configured to drive the operation bar 31 of the water valve 30 to move, as illustrated in FIG. 46, and each of the multiple non-acting portions 432c is configured to remove the operation bar 31; a resilient element 44c configured to elastically push the rotating member 43c; and a toothed drive mechanism 45c housed in the tubular part 41c, formed on the abutting segment 422c of the press member 42c, and connecting with the rotating member 43c. When the pressing segment 421c of the press member 42c is pressed and released, the abutting segment 422c pushes the rotating member 43c to move a distance, and the resilient element 44c matches with the toothed drive mechanism 45c to push the resilient element 44c, hence after the rotating member 43c revolves in a travel, it stops rotation, wherein in the travel, the rotating member 43c drives the operation bar 31 by using a non-acting portion 432c, an acting portion 431c adjacent to the non-acting portion 432c, a next non-acting portion 432c relative to the operation bar 31, and a next acting portion 431c with respect to the operation bar 31.

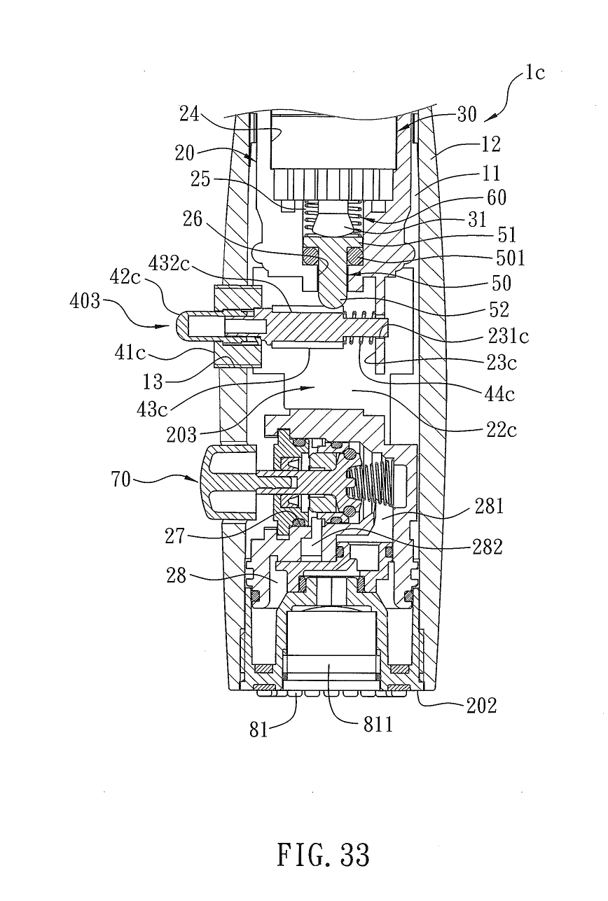

As illustrated in FIGS. 33-35, the acting portion 431c of the rotation device 403 actuates the operation bar 31 via the push column 50.

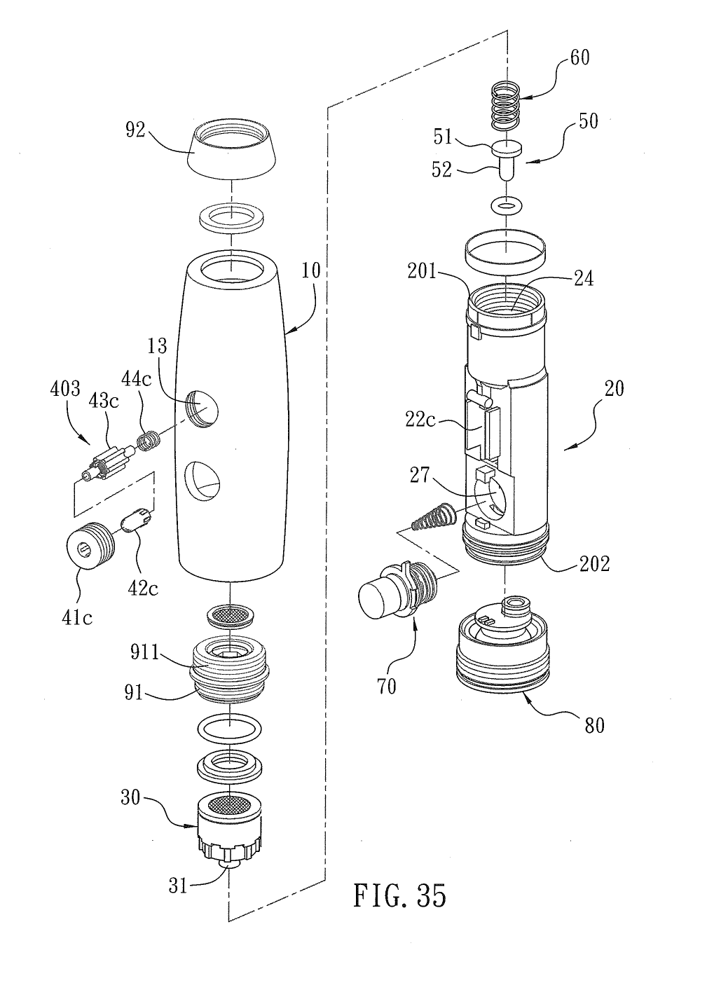

As shown in FIG. 35, the through hole 13 of the casing 10 is a screwing hole, the tubular part 41c of the rotation device 403 has outer threads for screwing with the screwing hole of the casing 10.

Referring to FIG. 32, the tubular part 41c has an aperture 411c defined therein, multiple troughs 412c separately arranged on an inner wall of the first aperture 411c, and multiple tilted positioning teeth 413c. As shown in FIGS. 38-40, the press member 42c is fitted in the aperture 411c of the tubular part 41c, the press member 42c includes a plurality of slide protrusions 424c formed on an outer wall thereof and slidably retained with the multiple troughs 412c respectively, and the press member 42c includes multiple tilted actuating teeth 425c formed on the abutting segment 422c; the rotating member 43c has a first post 433c extending outwardly from a first end thereof and rotatably fitted with the first opening 231c of the fixing cylinder 20, a second post 434c extending outwardly from a second end of the rotating member 43c and rotatably fitted with the second opening 423c of the press member 42c, the action zone 430c formed between the first post 433c and the second post 434c, and multiple tilted driven teeth 435c arranged between the action zone 430c and the second post 434c. The toothed drive mechanism 45c is comprised of the multiple tilted positioning teeth 413c of the tubular part 41c, and the multiple tilted actuating teeth 425c of the press member 42c, and the multiple tilted driven teeth 435c of the rotating member 43c.

When the press member 42c is pressed to move or is released, the multiple tilted actuating teeth 425c push the multiple tilted driven teeth 435c of the rotating member 43c to move away from the multiple tilted positioning teeth 413c of the tubular part 41c, and the resilient element 44c pushes the multiple tilted driven teeth 435c to rotatably fix on the multiple tilted positioning teeth 413c individually, hence the rotating member 43c rotates in the travel.

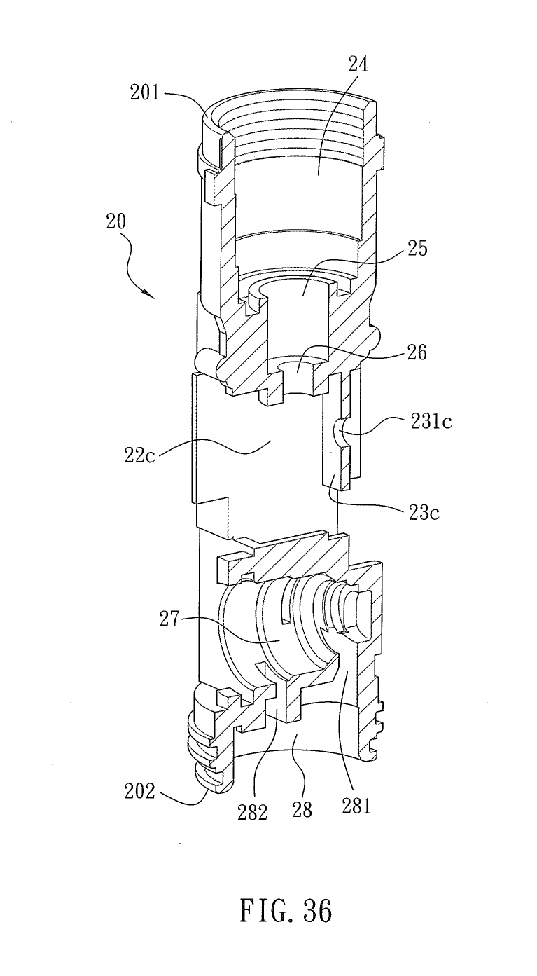

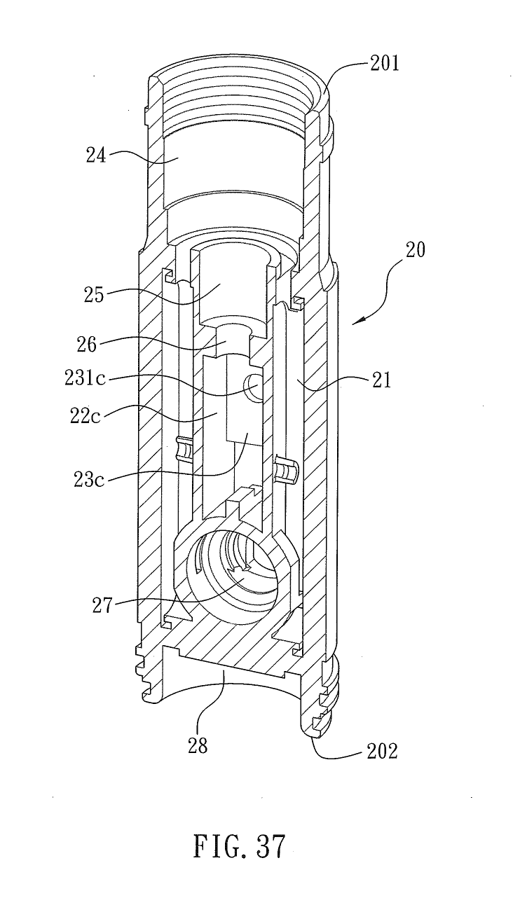

Each of the multiple acting portions 431c is an elongated rib; each of the multiple non-acting portions 432c is an elongated slot, and the multiple acting portions 431c abut against the operation bar 31 of the water valve 30 via the push column 50, when the press member 42c is pressed or is released, as shown in FIG. 36.

Furthermore, each non-acting portion 432c is configured to remove the operation bar 31 from the push column 50.

After pressing and releasing the press member 42c, the press member 42c moves back to an original position by way of the resilient element 44c and the toothed drive mechanism 45c, and the rotating member 43c moves back to the multiple non-acting portions 432c relative to the push column 50.

In this embodiment, the resilient element 44c is a compression spring and is fitted on the second post 434c of the rotating member 43c, wherein a first end of the resilient element 44c abuts against a part of the peripheral fence 23c of the fixing cylinder 20, and a second end of the resilient element 44c is biased against a stop cliff 436c between the action zone 430c and the first post 433c, as illustrated in FIG. 8.

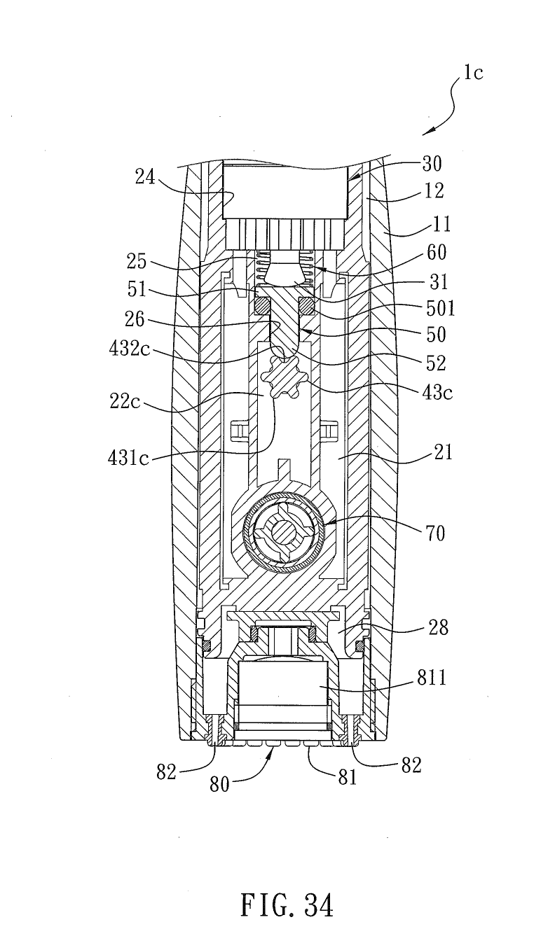

With reference to FIG. 32, the tubular part 41c has six troughs 412c and six tilted positioning teeth 413c, wherein an inner end of each of the six troughs 412c is defined by a lowest portion of each of the six tilted positioning teeth 413c. The press member 42c has six slide protrusions 424c and six tilted driving teeth 425c. The rotating member 43c has three tilted driven teeth 435c, wherein tilting directions and slopes of the six tilted positioning teeth 413c, the six tilted driving teeth 425c, and the three tilted driven teeth 435c are identical, hence after the press member 42c is pressed and is released, the rotating member 43c revolves in a travel of 60 degrees, for example, the rotating member 43c revolves from an imaginary position of the FIG. 33 to an imaginary position of FIG. 34. In other words, when the rotating member 43c revolves in a circle, it means that the rotating member 43c revolves in six travels, and each of the six travels is 60 degrees.

Referring to FIGS. 32-34, the six troughs 412c of the tubular part 41c has three deep troughs 414c and three shallow troughs 415c which are spaced from one another respectively, wherein the three tilted driven teeth 435c of the rotating member 43c slide into the three deep troughs 414c individually, as shown on the imaginary position of FIG. 34. The rotating member 43c has three limitation cliff 437c spaced from one another by the three tilted driven teeth 435c respectively, hence after the three tilted driven teeth 435c slide into the three deep troughs 414c individually, the three tilted driven teeth 435c are fixed by the three limitation cliff 437c and the six tilted positioning teeth 413c respectively, as illustrated in FIG. 35.

In addition, a distal end of the extension 52 of the push column 50 is driven by the multiple acting portions 431c of the rotating member 43c.

Referring to FIGS. 33-35, the touch spray head 1c further comprises a compression spring 60 configured to push the push column 50 to move back to an original position, after the rotating member 43c rotates in every travel.

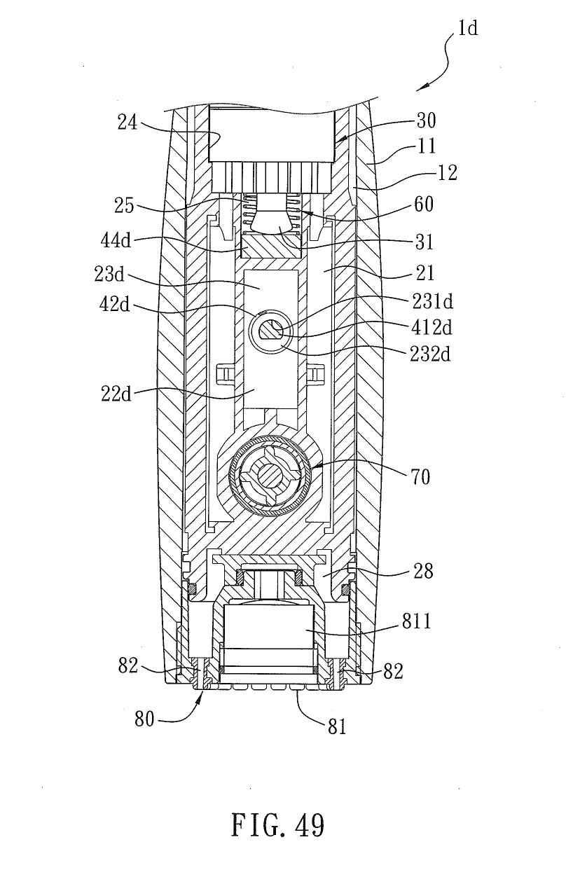

With reference to FIGS. 47-50, a difference of a touch spray head 1d of a fifth embodiment from that of the first embodiment comprises:

an accommodation chamber 22d formed in the receiving zone 203 of the fixing cylinder 20.

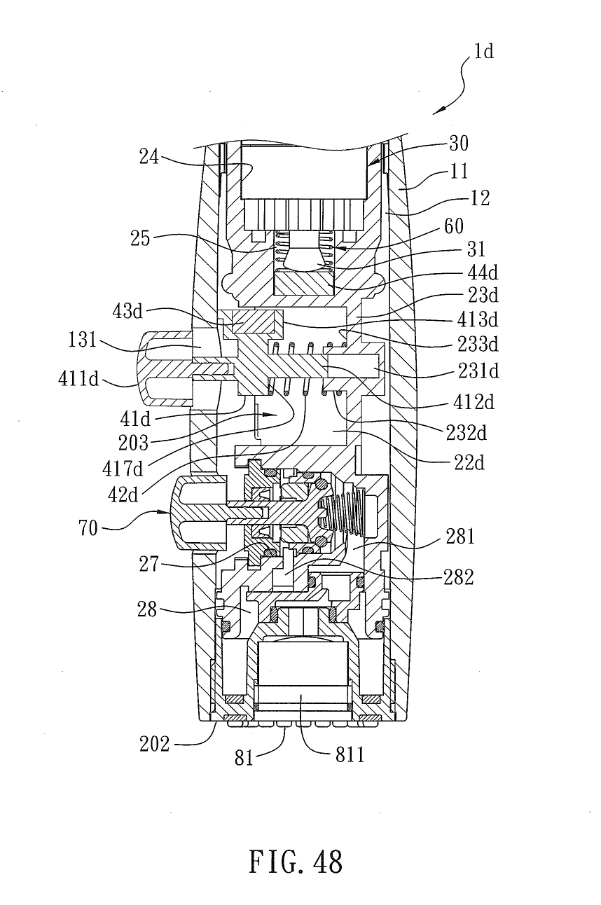

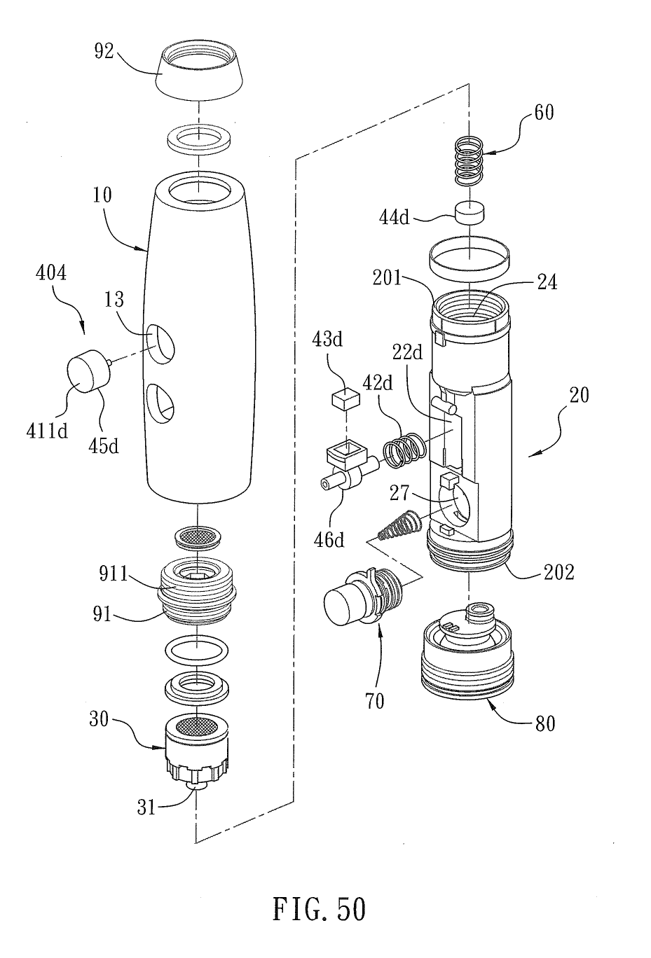

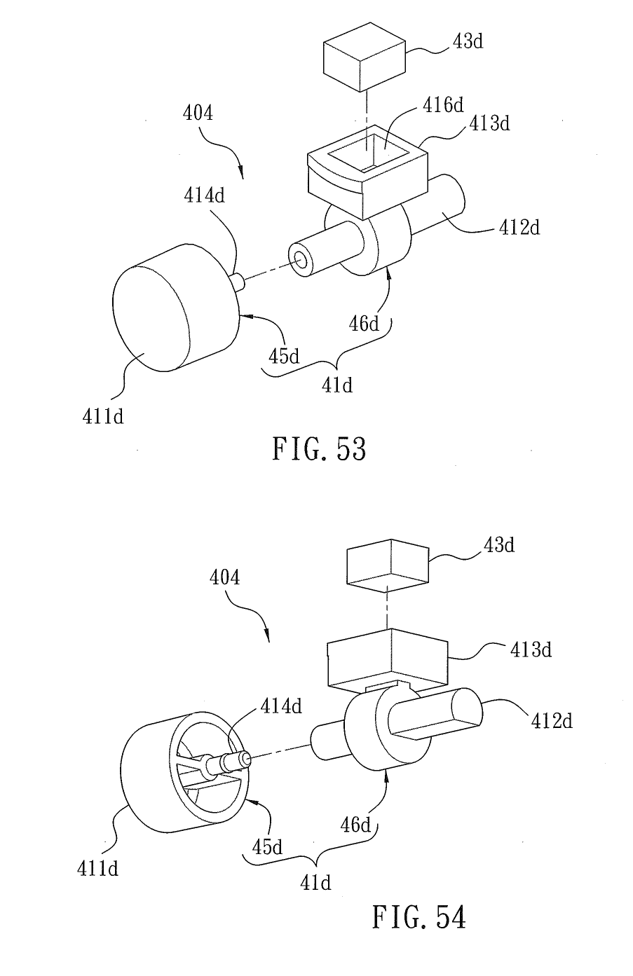

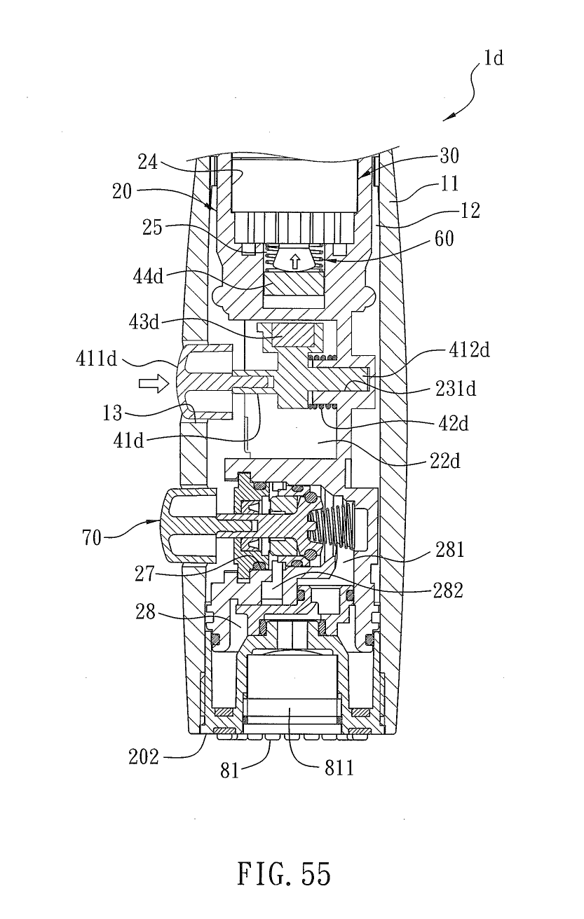

Referring to FIGS. 50, 53, and 54, the manual operation device 40 is a magnetic drive device 404 which includes a moving portion 41d housed in the accommodation chamber 22d and moving between a pressing position and a releasing position, wherein the moving portion 41d has a urging section 411d extending out of the through hole 13 of the casing 10 so as to be pressed by the user; an elastic element 42d configured to elastically act on the moving portion 41d so that the moving portion 41d stays at the pressing portion or returns back to the releasing position, as shown in FIG. 48; a first magnetic element 43d fixed on the moving portion 41d; a second magnetic element 44d movably accommodated in the fixing cylinder 20 and opposite to the operation bar 31 of the water valve 30, wherein when the moving portion 41d is pressed to move to the pressing position, it is magnetically driven by the second magnetic element 44d to touch the operation bar 30 to move, as shown in FIG. 55.

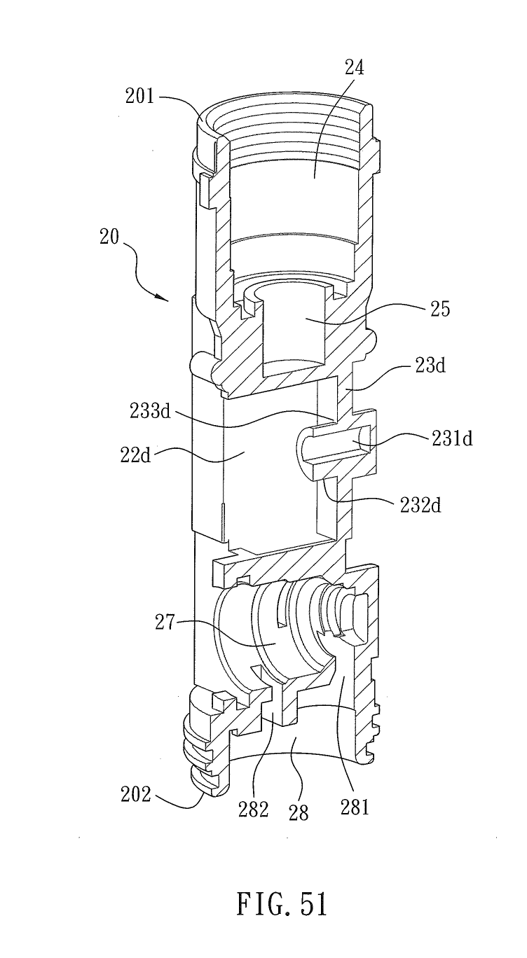

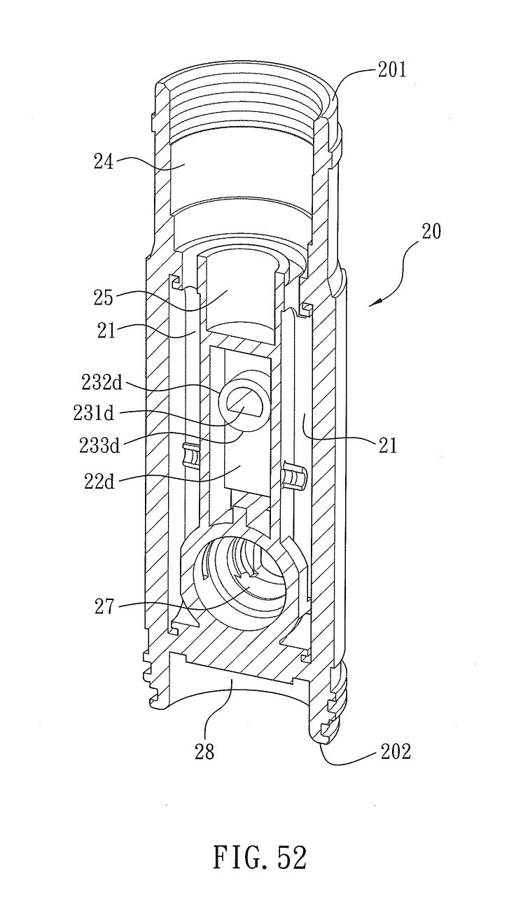

As shown in FIGS. 51-52, the second magnetic element 44d is accommodated in the groove 25 opposite to the operation bar 31.

When the moving portion 41d is located at the pressing position, the first magnetic element 43d closes to the second magnetic element 44d so as to repel against the second magnetic element 44d, hence the second magnetic element 44d is driven to movably touch the operation bar 31, as illustrated in FIG. 55. When the moving portion 41d is located at the releasing position, the first magnetic element 43d moves away from the second magnetic element 44d so as to decrease or vanish repulsion force between the first magnetic element 43d and the second magnetic element 44d, hence the second magnetic element 44d removes from the operation bar 31, as shown in FIG. 48.

Each of the first magnetic element 43d and the second magnetic element 44d is a magnet so that the first magnetic element 43d repels against the second magnetic element 44d, hence the second magnetic element 44d is driven to move back to an original position.

With reference to FIGS. 48 and 51, the accommodation chamber 22d has a guiding trench 231d defined thereon, the moving portion 41d has a press member 45d and a slider 46d connecting with the press member 45d; the press member 45d has the urging section 411d formed thereon; the slider 46d has a slidable peg 412d rotatably retained and moving in the guiding trench 231d, and the slider 46d has a mounting portion 413d configured to fix the first magnetic element 43d. The guiding trench 231d includes a first tangent plane formed on an inner wall thereof, and the slidable peg 412s has a second tangent plane formed on an outer wall thereof and mating with the first tangent plane, thus limiting rotation of the slider 46d. Thereafter, the first magnetic element 43d moves close to or away from the second magnetic element 44d straightly and does not rotate.

Referring to FIGS. 48, 53, and 54, the press member 45d has an extending segment 414d extending from the urging section 411d; the slider 46d has a first cutout 415d configured to accommodate the extending segment 414d, and the mounting portion 413d further has a second cutout 416d configured to house the first magnetic element 43d; the mounting portion 413d abuts against a part of the housing 10 inside an outer rim of the through hole 13 of the casing 10 so as to fix the moving portion 41d at the releasing position.

The moving portion 41d has a first biasing fringe 417d defined on one side thereof opposite to a distal end of the slidable peg 412d; the fixing cylinder 20 further includes an affixing tube 232d and a second biasing fringe 233d which are formed on the guiding trench 231d of the accommodation chamber 22d; the elastic element 42d is a compression spring fitted on the slidable peg 412d of the slider 46d and the affixing tube 232d, and two ends of the elastic element 42d abut against the first biasing fringe 417d and the second biasing fringe 233d respectively.

Referring to FIGS. 48 and 50, the compression spring 60 is accommodated in the groove 25 between the water valve 30 and the second magnetic element 44d so as to decrease or vanish repulsion force between the first magnetic element 43d and the second magnetic element 44d, hence the first magnetic element 43d and the second magnetic element 44d move back to original positions individually.

When the water valve is automatic, the operation bar 31 is driven to move so as to flow the water. Thereafter, the water valve moves back to an original position and turn off the water, hence turning off the water by pressing the driving portion 40a of the manual operation device 40 is not required.

When the water valve 30 is not automatic, it is turned off by manually pressing the driving portion 40a of the manual operation device 40.

Thereby, the operation bars 31 of the water valves 30 of the touch spray heads 1, 1a, 1b, 1c, 1d are driven by operating the driving portion 40a of the manual operation devices 40, thus starting/stopping the water supply easily and saving water consumption.

The water valves 30 of the touch spray heads 1, 1a, 1b, 1c, 1d are driven by operating the manual operation devices 40 so as to avoid manually touching and contaminating the water valves 30.

The touch spray heads 1 spray the water in different water spraying modes by way of the switch valve assemblies 70.

The pressing button 400 of the touch spray head 1 of the first embodiment is rotatably connected with the fixing cylinder 20 directly so as to simplify the touch spray head 1 and reduce fabrication cost.

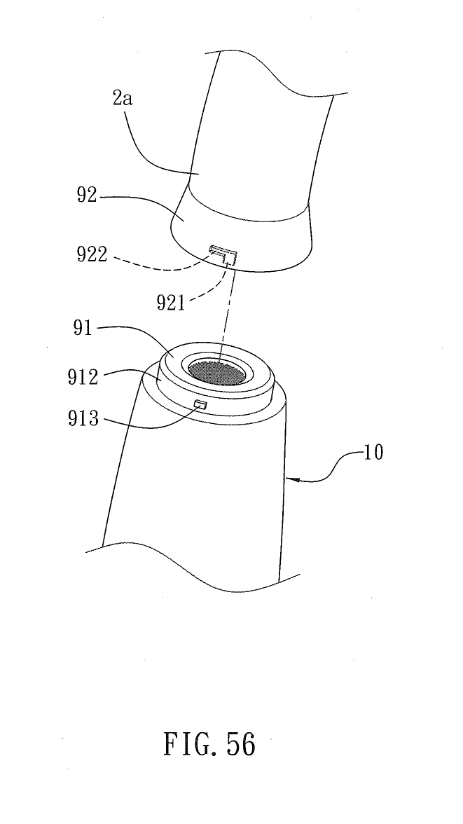

The inflow connectors 91 of the outlets 2a of the touch spray heads 1, 1a, 1b, 1c, 1d are screwed with the screw sleeves 92 respectively. Alternatively, each inflow connector 91 has a protruded section 912 formed thereon and has at least one engagement projection 913 arranged around an outer wall of the protruded section 912, as shown in FIG. 56, and each screw sleeve 92 has at least first indentation 921 defined on an inner wall thereof and has at least one second indentation 922 communicating with the at least one first indentation 921 so that the protruded section 912 of each inflow 91 extends out of the top of the casing 10, and the at least one engagement projection 913 rotates into the at least one first indentation 921 and retains in the at least one second indentation 922, thus connecting/removing each screw sleeve 92 with/from each inflow connector 91 quickly so as to replace or maintain each touch spray head 1, 1a, 1b, 1c, 1d freely.

While the preferred embodiments of the invention have been set forth for the purpose of disclosure, modifications of the disclosed embodiments of the invention as well as other embodiments thereof may occur to skilled in the art. Accordingly, the appended claims are intended to cover all embodiments which do not depart from the spirit and scope of the invention.

What is claimed is:

1. A touch spray head being removably connected on an outlet of a faucet body and comprising:
a casing including a surrounding fence, an accommodation space defined inside the surrounding fence, and a through hole formed on the surrounding fence and communicating with the accommodation space;
a fixing cylinder housed in the accommodation space of the casing and including an inlet segment communicating with the outlet of the faucet body, an outlet segment, at least one first orifice defined between the inlet segment and the outlet segment, and a receiving zone;
a water valve accommodated in the fixing cylinder and including an operation bar touched to movably turn on the water valve so that the water flows into the at least one first orifice of the fixing cylinder from the outlet of the faucet body;
a manual operation device housed in the receiving zone of the fixing cylinder and the through hole of the casing, and the manual operation device including a driving portion formed in the through hole so as to be driven by a user to actuate the operation bar of the water valve to move.

2. The touch spray head as claimed in claim 1, wherein the fixing cylinder further includes a second orifice formed in the receiving zone and includes a first connection portion; the manual operation device includes a pressing button which has a force portion and a drive stem extending from the force portion; a part of the drive stem is limited in the second orifice of the fixing cylinder; the force portion has an external face and an internal face, wherein the external face has an operating zone configured to form the driving portion, the internal face has a second connection portion rotatably connected with the first connection portion and located at the drive stem opposite to the operating zone, hence when the operating zone is pressed, the drive stem in the second orifice touches the operation bar of the water valve to move by way of the first connection portion and the second connection portion.

3. The touch spray head as claimed in claim 2, wherein the fixing cylinder further includes a receiving cavity located on the inlet segment, a groove formed in a bottom of the receiving cavity, and a third orifice passing through a bottom of the groove, wherein the at least one first orifice communicates with the receiving cavity and the outlet segment; the water valve is accommodated in the receiving cavity, and the operation bar is housed in the groove.

4. The touch spray head as claimed in claim 3 further comprising a push column extending out of the groove from the third orifice and configured to push the drive stem of the pressing button to actuate the operation bar.

5. The touch spray head as claimed in claim 2, wherein the first connection portion of the fixing cylinder is at least one rotary shaft; the second connection portion of the pressing button is at least one rotatable tab configured to retain with the at least one rotary shaft.

6. The touch spray head as claimed in claim 5, wherein the first connection portion is a rotary shaft, and the second connection portion is two rotatable tabs.

7. The touch spray head as claimed in claim 4, wherein the push column includes a fitting portion sliding upward and downward in the groove, and the push column includes an extension extending out of the third orifice from the fitting portion; the fitting portion is configured to drive the operation bar of the water valve; a distal end of the extension is driven by the drive stem of the pressing button.

8. The touch spray head as claimed in claim 7 further comprising a compression spring accommodated in the groove between the water valve and the fitting portion of the push column so that the push column and the pressing button are pushed by the compressing spring to move back to original positions respectively.

9. The touch spray head as claimed in claim 2, wherein the second orifice of the fixing cylinder has two opposite limiting fringes defined therein so that when the drive stem of the pressing button is pressed and released, the drive stem moves between the two opposite limiting fringes.

10. The touch spray head as claimed in claim 2, wherein the second connection portion of the pressing button is opposite to the operating zone of the pressing button.

11. The touch spray head as claimed in claim 7, wherein the extension of the push column has a seal washer fitted thereon and contacting with the groove so as to avoid water leakage out of the third orifice from the groove.

12. The touch spray head as claimed in claim 1, wherein the casing includes a housing portion formed on the surrounding fence thereof and communicating with the accommodation space, and the housing portion has the through hole; the receiving zone of the fixing cylinder has a first notch formed therein, a peripheral fence of the first notch has a connection portion and an affix portion; the manual operation device is a rotation device housed in the housing portion of the casing, and the rotation device includes a rotatable knob rotated by the user and a drive member, a part which is accommodated in the first notch of the fixing cylinder; the drive member has a rotary shaft and a cam located on the rotary shaft, wherein a first end of the rotary shaft couples with the rotatable knob, and a second end of the rotary shaft rotatably connects with the connection portion of the fixing cylinder; the rotation device further includes a coil spring, a first end of which connects with the drive member, and a second end of the coil spring couples with the affix portion of the fixing cylinder; the rotatable knob is rotated by the user to drive the drive member to rotate so that the cam of the drive member actuates the operation bar of the water valve to move, and the coil spring is tightened, hence after the cam and rotatable knob are released, the coil spring returns to an original position.

13. The touch spray head as claimed in claim 12, wherein the fixing cylinder further includes a receiving cavity located on the inlet segment, a groove formed in a bottom of the receiving cavity, and a third orifice passing through a bottom of the groove, wherein the at least one first orifice communicates with the receiving cavity and the outlet segment; the water valve is accommodated in the receiving cavity, and the operation bar is housed in the groove.

14. The touch spray head as claimed in claim 13 further comprising a push column extending out of the groove from the third orifice and configured to push the cam of the rotation device to actuate the operation bar.

15. The touch spray head as claimed in claim 12, wherein the housing portion of the casing has a recess and has the through hole formed in a bottom of the recess, wherein the through hole is a screwing hole communicating with the accommodation space; the rotation device further includes a holding seat screwing with the screwing hole, and the holding seat has a coupling opening so that the first end of the rotary shaft rotatably couples with the rotatable knob via the coupling opening.

16. The touch spray head as claimed in claim 15, wherein the holding seat has a first threaded portion arranged on an outer wall thereof and a defining fence extending outward from the first threaded portion, hence the first threaded portion screws with the screwing hole, and the defining fence abuts against the bottom of the recess.

17. The touch spray head as claimed in claim 15, wherein the holding seat has a first non-circular slot defined on an outer edge thereof and configured to retain with a rotation tool and to screw the holding seat with the screwing hole.

18. The touch spray head as claimed in claim 12, wherein the rotatable knob has a second non-circular slot formed in an inner wall thereof, and the rotary shaft of the drive member has a non-circular connector formed on an outer end thereof so that the non-circular connector retains in the second non-circular slot to connect the rotatable knob and the drive member together.

19. The touch spray head as claimed in claim 12, wherein the cam of the drive member is one-piece formed on the rotary shaft.

20. The touch spray head as claimed in claim 12, wherein the connection portion is a connection hole.

21. The touch spray head as claimed in claim 12, wherein the drive member has a second notch defined on one end thereof adjacent to the cam, a first fitting portion of the fixing cylinder is a post so that the coil spring fits on the rotary shaft and a first end of the coil spring fixes in the second notch, a second end of the coil spring fits on the first fitting portion.

22. The touch spray head as claimed in claim 14, wherein the push column includes a fitting portion sliding upward and downward in the groove, and the push column includes an extension extending out of the third orifice from the fitting portion; the fitting portion is configured to drive the operation bar of the water valve; a distal end of the extension is driven by the cam.

23. The touch spray head as claimed in claim 22 further comprising a compression spring accommodated in the groove between the water valve and the fitting portion of the push column so that the push column and the rotation device are pushed by the compressing spring to move back to original positions respectively.

24. The touch spray head as claimed in claim 14 further comprising a compression spring accommodated in the groove between the water valve and the push column so that the push column and the rotation device are pushed by the compressing spring to move back to original positions respectively.

25. The touch spray head as claimed in claim 22, wherein the extension of the push column has a seal washer fitted thereon and contacting with the groove so as to avoid water leakage out of the third orifice from the groove.

26. The touch spray head as claimed in claim 1, wherein the surrounding fence of the casing having a positioning portion formed thereon, and the positioning portion has the through hole; the fixing cylinder further includes a second orifice formed in the receiving zone of the fixing cylinder; the manual operation device is a pushing button sliding within a predetermined distance on the positioning portion, and the pushing button includes a movable portion and a drive stem extending from the movable portion; a part of the drive stem is limited in the second orifice of the fixing cylinder, and the drive stem is pushed to move on the movable portion of the pushing button along the positioning portion so as to drive the operation bar of the water valve to move.

27. The touch spray head as claimed in claim 26, wherein the fixing cylinder further includes a receiving cavity located on the inlet segment, a groove formed in a bottom of the receiving cavity, and a third orifice passing through a bottom of the groove, wherein the at least one first orifice communicates with the receiving cavity and the outlet segment; the water valve is accommodated in the receiving cavity, and the operation bar is housed in the groove.

28. The touch spray head as claimed in claim 27 further comprising a push column extending out of the groove from the third orifice and configured to push the drive stem of the pushing button to actuate the operation bar.

29. The touch spray head as claimed in claim 26, wherein the positioning portion of the casing has a first trench in which the through hole is formed; the movable portion of the pushing button slidably retains and moves in the first trench.

30. The touch spray head as claimed in claim 29, wherein the movable portion has an external face configured to form the driving portion, and the movable portion has two flexible hooks extending into the casing from the external face, wherein the two flexible hooks respectively hook with two opposite ends of an internal fence of the casing via the through hole of the casing.

31. The touch spray head as claimed in claim 29, wherein the pushing button is pushed upwardly along the fixing cylinder.

32. The touch spray head as claimed in claim 28, wherein the push column includes a fitting portion sliding upward and downward in the groove, and the push column includes an extension extending out of the third orifice from the fitting portion; the fitting portion is configured to drive the operation bar of the water valve; a distal end of the extension is driven by the drive stem of the pushing button.

33. The touch spray head as claimed in claim 32 further comprising a compression spring accommodated in the groove between the water valve and the fitting portion of the push column so that the push column and the pushing button are pushed by the compressing spring to move back to original positions respectively.

34. The touch spray head as claimed in claim 28 further comprising a compression spring accommodated in the groove between the water valve and the fitting portion of the push column so that the push column and the pushing button are pushed by the compressing spring to move back to original positions respectively.

35. The touch spray head as claimed in claim 26, wherein the second orifice of the fixing cylinder has two opposite limiting fringes formed therein so that the drive stem of the pushing button moves between the two opposite limiting fences after pushing and releasing the pushing button.

36. The touch spray head as claimed in claim 32, wherein the extension of the push column has a seal washer fitted thereon and contacting with the groove so as to avoid water leakage out of the third orifice from the groove.

37. The touch spray head as claimed in claim 1, wherein the fixing cylinder includes an accommodating chamber formed in the receiving zone thereof, and the accommodating chamber has a first opening formed on a peripheral fence thereof; the manual operation device is a rotation device, and the rotation device includes a tubular part accommodated in the through hole; a press member fitted in the tubular part, wherein the press member has a force exerting segment configured to form the driving portion, an abutting segment, a second opening defined in the press member; a rotating member rotatably connected with the first opening of the fixing cylinder and the second opening of the press member, wherein the rotating member has an action zone formed on an outer wall thereof, and the action zone has multiple acting portions and multiple non-acting portions which are spaced from one another by the multiple acting portions respectively, wherein the multiple acting portions are configured to drive the operation bar of the water valve, and each of the multiple non-acting portions is configured to remove the operation bar; a resilient element configured to elastically push the rotating member; and a toothed drive mechanism housed in the tubular part, formed on the abutting segment of the press member, and connecting with the rotating member; when the pressing segment of the press member is pressed and released, the abutting segment pushes the rotating member to move a distance, and the resilient element matches with the toothed drive mechanism to push the resilient element, hence after the rotating member revolves in a travel, it stops rotation, wherein in the travel, the rotating member drives the operation bar by using a non-acting portion, an acting portion adjacent to the non-acting portion, a next non-acting portion relative to the operation bar, and a next acting portion with respect to the operation bar.

38. The touch spray head as claimed in claim 37, wherein the fixing cylinder further includes a receiving cavity located on the inlet segment, a groove formed in a bottom of the receiving cavity, and a third orifice passing through a bottom of the groove, wherein the at least one first orifice communicates with the receiving cavity and the outlet segment; the water valve is accommodated in the receiving cavity, and the operation bar is housed in the groove.

39. The touch spray head as claimed in claim 38 further comprising a push column extending out of the groove from the third orifice and configured to push the multiple acting portions of the rotation device to actuate the operation bar.

40. The touch spray head as claimed in claim 37, wherein the through hole of the casing is a screwing hole; the tubular part of the rotation device has outer threads for screwing with the screwing hole of the casing.

41. The touch spray head as claimed in claim 37, wherein the tubular part has an aperture defined therein, multiple troughs separately arranged on an inner wall of the first aperture, and multiple tilted positioning teeth; the press member is fitted in the aperture of the tubular part, the press member includes a plurality of slide protrusions formed on an outer wall thereof and slidably retained with the multiple troughs respectively, and the press member includes multiple tilted actuating teeth formed on the abutting segment; the rotating member has a first post extending outwardly from a first end thereof and rotatably fitted with the first opening of the fixing cylinder, a second post extending outwardly from a second end of the rotating member and rotatably fitted with the second opening of the press member, the action zone formed between the first post and the second post, and multiple tilted driven teeth arranged between the action zone and the second post; the toothed drive mechanism is comprised of the multiple tilted positioning teeth of the tubular part, and the multiple tilted actuating teeth of the press member, and the multiple tilted driven teeth of the rotating member; when the press member is pressed to move or is released, the multiple tilted actuating teeth push the multiple tilted driven teeth of the rotating member to move away from the multiple tilted positioning teeth of the tubular part, and the resilient element pushes the multiple tilted driven teeth to rotatably fix on the multiple tilted positioning teeth individually, hence the rotating member rotates in the travel.

42. The touch spray head as claimed in claim 41, wherein each of the multiple acting portions is an elongated rib, and each of the multiple non-acting portions is an elongated slot.

43. The touch spray head as claimed in claim 41, wherein the resilient element is a compression spring and is fitted on the second post of the rotating member, wherein a first end of the resilient element abuts against a part of the peripheral fence of the fixing cylinder, and a second end of the resilient element is biased against a stop cliff between the action zone and the first post.

44. The touch spray head as claimed in claim 41, wherein the tubular part has six troughs and six tilted positioning teeth, wherein an inner end of each of the six troughs is defined by a lowest portion of each of the six tilted positioning teeth; the press member has six slide protrusions and six tilted driving teeth; the rotating member has three tilted driven teeth, wherein tilting directions and slopes of the six tilted positioning teeth, the six tilted driving teeth, and the three tilted driven teeth are identical.

45. The touch spray head as claimed in claim 44, wherein the six troughs of the tubular part 41c has three deep troughs and three shallow troughs which are spaced from one another respectively, wherein the three tilted driven teeth of the rotating member slide into the three deep troughs individually; the rotating member has three limitation cliff spaced from one another by the three tilted driven teeth respectively.

46. The touch spray head as claimed in claim 39 further comprising a compression spring accommodated in the groove between the water valve and the fitting portion of the push column so that the push column and the rotating member are pushed by the compressing spring to move back to original positions respectively.

47. The touch spray head as claimed in claim 46 further comprising a compression spring accommodated in the groove between the water valve and the fitting portion of the push column so that the push column and the rotating member are pushed by the compressing spring to move back to original positions respectively.

48. The touch spray head as claimed in claim 39, wherein the push column includes a fitting portion sliding upward and downward in the groove, and the push column includes an extension extending out of the third orifice from the fitting portion; the fitting portion is configured to drive the operation bar of the water valve; a distal end of the extension is driven by the drive stem of the pushing button.

49. The touch spray head as claimed in claim 46, wherein the extension of the push column has a seal washer fitted thereon and contacting with the groove so as to avoid water leakage out of the third orifice from the groove.

50. The touch spray head as claimed in claim 1, wherein the fixing cylinder includes an accommodating chamber formed in the receiving zone thereof, the manual operation device is a magnetic drive device which includes a moving portion housed in the accommodation chamber and moving between a pressing position and a releasing position, wherein the moving portion has a urging section extending out of the through hole of the casing so as to be pressed by the user; an elastic element configured to elastically act on the moving portion so that the moving portion stays at the pressing portion or returns back to the releasing position; a first magnetic element fixed on the moving portion; a second magnetic element movably accommodated in the fixing cylinder and opposite to the operation bar of the water valve, wherein when the moving portion is pressed to move to the pressing position, it is magnetically driven by the second magnetic element to touch the operation bar to move.

51. The touch spray head as claimed in claim 50, wherein the fixing cylinder further includes a receiving cavity located on the inlet segment, a groove formed in a bottom of the receiving cavity, and the third orifice passing communicating with the receiving cavity and the outlet segment; the water valve is accommodated in the receiving cavity, and the operation bar is housed in the groove; the second magnetic element is accommodated in the groove opposite to the operation bar.

52. The touch spray head as claimed in claim 51, wherein when the moving portion is located at the pressing position, the first magnetic element closes to the second magnetic element so as to repel against the second magnetic element, hence the second magnetic element is driven to movably touch the operation bar; when the moving portion is located at the releasing position, the first magnetic element moves away from the second magnetic element so as to decrease or vanish repulsion force between the first magnetic element and the second magnetic element, hence the second magnetic element removes from the operation bar.

53. The touch spray head as claimed in claim 52, wherein each of the first magnetic element and the second magnetic element is a magnet.

54. The touch spray head as claimed in claim 50, wherein the accommodation chamber has a guiding trench defined thereon; the moving portion has a press member and a slider connecting with the press member; the press member has the urging section formed thereon; the slider has a slidable peg rotatably retained and moving in the guiding trench, and the slider has a mounting portion configured to fix the first magnetic element.

55. The touch spray head as claimed in claim 54, wherein the press member has an extending segment extending from the urging section; the slider has a first cutout configured to accommodate the extending segment, and the mounting portion further has a second cutout configured to house the first magnetic element; the mounting portion abuts against a part of the housing inside an outer rim of the through hole of the casing so as to fix the moving portion at the releasing position.

56. The touch spray head as claimed in claim 54, wherein the fixing cylinder further includes a receiving cavity located on the inlet segment, a groove formed in a bottom of the receiving cavity, and the third orifice passing communicating with the receiving cavity and the outlet segment; the water valve is accommodated in the receiving cavity, and the operation bar is housed in the groove; the second magnetic element is accommodated in the groove opposite to the operation bar.

57. The touch spray head as claimed in claim 56, wherein when the moving portion is located at the pressing position, the first magnetic element closes to the second magnetic element so as to repel against the second magnetic element, hence the second magnetic element is driven to movably touch the operation bar; when the moving portion is located at the releasing position, the first magnetic element moves away from the second magnetic element so as to decrease or vanish repulsion force between the first magnetic element and the second magnetic element, hence the second magnetic element removes from the operation bar.

58. The touch spray head as claimed in claim 57, wherein each of the first magnetic element and the second magnetic element is a magnet.

59. The touch spray head as claimed in claim 54, wherein the moving portion has a first biasing fringe defined on one side thereof opposite to a distal end of the slidable peg; the fixing cylinder further includes an affixing tube and a second biasing fringe which are formed on the guiding trench of the accommodation chamber; the elastic element is a compression spring fitted on the slidable peg of the slider and the affixing tube, and two ends of the elastic element abut against the first biasing fringe and the second biasing fringe respectively.

60. The touch spray head as claimed in claim 58 further comprising a compression spring accommodated in the groove between the water valve and the second magnetic element so as to decrease or vanish repulsion force between the first magnetic element and the second magnetic element, hence the first magnetic element and the second magnetic element move back to original positions individually.

61. The touch spray head as claimed in claim 52 further comprising a compression spring accommodated in the groove between the water valve and the second magnetic element so as to decrease or vanish repulsion force between the first magnetic element and the second magnetic element, hence the first magnetic element and the second magnetic element move back to original positions individually.

62. The touch spray head as claimed in claim 1 further comprising a switch valve assembly arranged on the fixing cylinder and configured to switch to water spraying mode, and the touch spray head comprising a water spray set; wherein the switch valve assembly is pressed so as to guide the water to the water spray set from the at least one first orifice, thus producing at least two water spraying modes.

63. The touch spray head as claimed in claim 62, wherein, wherein the water spray set is configured to flow the water in a central spraying mode and a peripheral spraying mode.

64. The touch spray head as claimed in claim 62, wherein the fixing cylinder includes a first trench communicating with the at least one first one orifice so as to fix the switch valve assembly in the first trench; the fixing cylinder further includes a second trench for accommodating the water spray set, wherein the second trench has a central channel and a peripheral channel communicating with the first trench; the water spray set includes a first aperture communicating with the central channel so as to spray the water out of the first aperture in the central spraying mode, and the water spray set includes multiple second apertures communicating with the peripheral channel so as to spray the water from the multiple second apertures in the peripheral spraying mode.

65. The touch spray head as claimed in claim 1, wherein the fixing cylinder further includes a receiving cavity located on the inlet segment, a groove formed in a bottom of the receiving cavity, and the at least one first orifice communicates with the receiving cavity and the outlet segment; the water valve is accommodated in the receiving cavity, and the operation bar is housed in the groove.

66. The touch spray head as claimed in claim 65 further comprising an inflow connector screwed in a top of the receiving cavity, and the inflow connector having a threaded connecting portion extending out of a top of the casing so as to screw with a screw sleeve on the outlet of the faucet body.

67. The touch spray head as claimed in claim 65 further comprising an inflow connector screwed in a top of the receiving cavity, and the inflow connector has a threaded connecting portion extending out of a top of the casing, wherein the inflow connector has a protruded section formed thereon and has at least one engagement projection arranged around an outer wall of the protruded section and rotatably retained in a screw sleeve formed on the outlet of the faucet body.
